(19) United States
(12) Patent Application Publication
(10) Pub. No.: US 2024/0320762 A1
(43) Pub. Date: Sep. 26, 2024

(54) MANAGEMENT METHOD FOR MANUFACTURING LINE

(71) Applicant: Kioxia Corporation, Tokyo (JP)

(72) Inventor: Teruhiko TENNOJI, Yokkaichi (JP)

(73) Assignee: Kioxia Corporation, Tokyo (JP)

(21) Appl. No.: 18/597,293

(22) Filed: Mar. 6, 2024

(30) Foreign Application Priority Data
Mar. 20, 2023 (JP) 2023-043869

(51) Int. Cl. G06Q 50/04; G06Q 10/087

(52) U.S. Cl. CPC G06Q 50/04; G06Q 10/087

(57) ABSTRACT

According to an embodiment, there is provided a management method for a manufacturing line. The management method includes obtaining a fluctuation characteristic including at least one of an arrival fluctuation characteristic of a lot to a process area, a capability fluctuation characteristic of the process area, or a stay fluctuation characteristic of the lot in the process area in a manufacturing line in which multiple process areas including the process area are arranged, the multiple process areas each including multiple resources. The management method includes obtaining inventory information regarding an inventory to be provided in the process area depending on the fluctuation characteristic.

### CROSS-REFERENCE TO RELATED APPLICATIONS

This application is based upon and claims the benefit of priority from Japanese Patent Application No. 2023-043869, filed on Mar. 20, 2023; the entire contents of which are incorporated herein by reference.

### FIELD

Embodiments described herein relate generally to a management method for a manufacturing line.

### BACKGROUND

In a manufacturing line, when a lot is input to a process area including multiple resources, the resources operate to process the lot. In a manufacturing line, it is desirable to be able to process lots efficiently.

### BRIEF DESCRIPTION OF THE DRAWINGS

FIG. 1 is a diagram illustrating a configuration of a manufacturing line according to a first embodiment;

FIGS. 2A to 2C are graphs illustrating fluctuation in the inventory quantity depending on fluctuation in arrival of lots to a resource and fluctuation in the capability of the resource in the first embodiment;

FIGS. 3A to 3C are graphs illustrating a relationship between the inventory capacity shortage, the throughput, and the turn around time (TAT), respectively, and fluctuation in the first embodiment;

FIG. 4 is a diagram illustrating a functional configuration of a management system according to the first embodiment;

FIGS. 5A to 5C are graphs illustrating the occurrence probability of an operation loss in the first embodiment;

FIG. 6 is a diagram illustrating a hardware configuration of the management system according to the first embodiment;

FIG. 7 is a flowchart illustrating a schematic operation of the management system of the first embodiment;

FIG. 8 is a flowchart illustrating processing of obtaining a fluctuation characteristic in the first embodiment;

FIG. 9 is a flowchart illustrating processing of obtaining inventory information in the first embodiment;

FIG. 10 is a diagram illustrating a configuration of a manufacturing line in a second embodiment;

FIG. 11 is a diagram illustrating a functional configuration of a management system according to the second embodiment;

FIG. 12 is a flowchart illustrating processing of obtaining a fluctuation characteristic in the second embodiment;

FIG. 13 is a flowchart illustrating processing of obtaining inventory information according to the second embodiment;

FIG. 14 is a diagram illustrating a configuration of a manufacturing line in a third embodiment;

FIG. 15 is a diagram illustrating a functional configuration of a management system according to the third embodiment;

FIGS. 16A and 16B are diagrams illustrating circular reference of equations in the third embodiment;

FIG. 17 is a flowchart illustrating processing of obtaining a fluctuation characteristic in the third embodiment;

FIG. 18 is a flowchart illustrating processing of obtaining inventory information in the third embodiment;

FIG. 19 is a diagram illustrating a configuration of a manufacturing line in the third embodiment;

FIG. 20 is a diagram illustrating a functional configuration of a management system according to a fourth embodiment;

FIG. 21 is a graph illustrating inventory fluctuations in two adjacent process areas in the fourth embodiment;

FIG. 22 is a flowchart illustrating processing of obtaining a fluctuation characteristic in the fourth embodiment; and

FIG. 23 is a flowchart illustrating processing of obtaining inventory information in the fourth embodiment.

### DETAILED DESCRIPTION

In general, according to one embodiment, there is provided a management method for a manufacturing line. The management method includes obtaining a fluctuation characteristic including at least one of an arrival fluctuation characteristic of a lot to a process area, a capability fluctuation characteristic of the process area, or a stay fluctuation characteristic of the lot in the process area in a manufacturing line in which multiple process areas including the process area are arranged, the multiple process areas each including multiple resources. The management method includes obtaining inventory information regarding an inventory to be provided in the process area depending on the fluctuation characteristic.

Exemplary embodiments of a management method for a manufacturing line will be explained below in detail with reference to the accompanying drawings. The present invention is not limited to the following embodiments.

### First Embodiment

A management method for a manufacturing line according to a first embodiment manages the manufacturing line in which multiple process areas are arranged. Each of the process areas includes multiple resources. In the manufacturing line, when a lot is input to a process area, resources operate to process the lot. In the management method for the manufacturing line, measures are taken to efficiently perform lot processing in a manufacturing line.

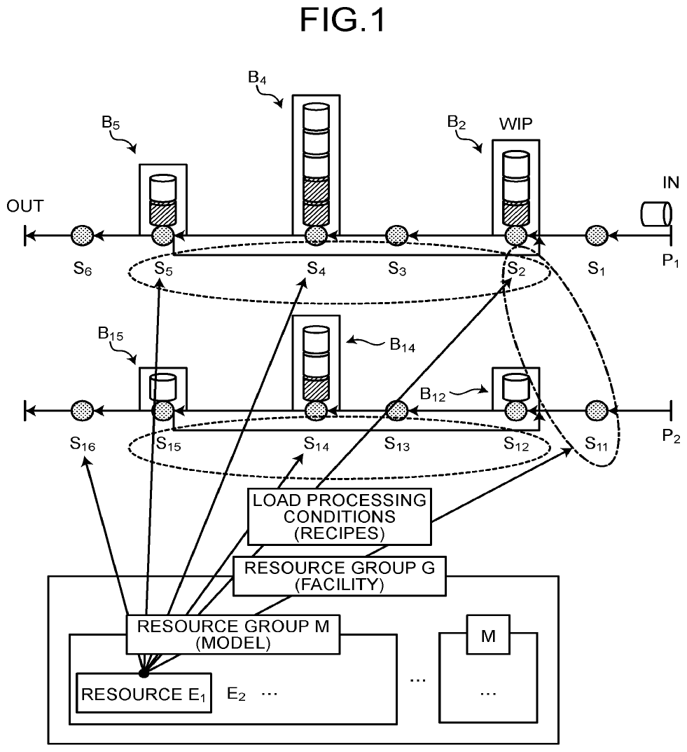

FIG. 1 is a diagram illustrating a configuration of the manufacturing line according to the first embodiment. In a manufacturing factory for manufacturing a manufacturing object, there is multiple manufacturing lines P₁ and P₂. The multiple manufacturing lines P₁ and P₂ correspond to multiple manufacturing objects OB₁ and OB₂. In the manufacturing line P₁, the manufacturing object OB₁ is manufactured, and in the manufacturing line P₂, the manufacturing object OB₂ is manufactured. Although the two manufacturing lines P₁ and P₂ are illustrated in FIG. 1, three or more manufacturing lines may be arranged in the manufacturing factory.

As illustrated in FIG. 1, multiple process areas S is arranged in a manufacturing line P. In FIG. 1, the manufacturing line P₁ in which six process areas S₁ to S₆ are arranged in order and the manufacturing line P₂ in which six process areas S₁₁ to S₁₆ are arranged in order are illustrated as an example. The number of process areas arranged in each manufacturing line P may be five or less or seven or more.

The multiple process areas S₁ to S₆ in the manufacturing line P₁ corresponds to multiple processes in a manufacturing method of a manufacturing object OB. Similarly, the multiple process areas S₁₁ to S₁₆ in the manufacturing line P₂ corresponds to multiple processes in a manufacturing method of a manufacturing object. In a case where the manufacturing object OB is a semiconductor device, the multiple processes include processes such as coating, exposure, development, etching, cleaning, impurity introduction, film formation, and heat treatment of a semiconductor substrate.

In each process area S, one or more resources E are arranged from a resource group M. The resource group M includes multiple resources E. In a case where the manufacturing object OB is a semiconductor device, each resource E is a semiconductor manufacturing device that performs processing of the process. In a case where the process is a coating process, the resource E includes a coating device. In a case where the process is an exposure process, the resource E includes an exposure device. In a case where the process is a developing process, the resource E includes a developing device. In a case where the process is an etching process, the resource E includes an etching device. In a case where the process is a cleaning process, the resource E includes a cleaning device. In a case where the process is an impurity introduction process, the resource E includes an ion implantation device. In a case where the process is a film forming process, the resource E includes a film forming device. In a case where the process is a heat treatment process, the resource E includes a heat treatment device.

An object to be processed in a resource E to manufacture the manufacturing object OB will be referred to as a lot. The lot includes one or more substrates to be mounted on a hoop (not illustrated) and can be mounted on the hoop in the manufacturing line P and be conveyed among the resources E by a conveyance device (not illustrated) or the like. In a case where the resource E is a single wafer processing type, substrates are processed one by one by the resource E, and in a case where the resource E is a batch type, the substrates are processed lot by lot by the resource E. Hereinafter, for the sake of simplicity, it is based on the premise that lots are processed by the resources E.

In a case where the manufacturing object OB is a semiconductor device, the manufacturing lines P may include multiple process areas S that is reenterable. For example, the multiple process areas S₁ to S₆ in the manufacturing line P₁ may include multiple reenterable process areas S₂ to S₅ as illustrated in FIG. 1 by being encircled by a dotted line. The multiple process areas S₁₁ to S₁₆ in the manufacturing line P₂ may include multiple reenterable process areas S₁₂ to S₁₅ as illustrated in FIG. 1 by being encircled by a dotted line.

In a case where the manufacturing object OB is a semiconductor device, the multiple process areas S may include process areas S compatible among multiple manufacturing lines P. For example, the process area S₂ of the manufacturing line P₁ and the process area Su₁ of the manufacturing line P₂ are similar processes and have similar processing content as indicated by being encircled by a one-dot chain line in FIG. 1, and different lots corresponding to different manufacturing objects OB may be allowed to be processed by a common recipe by the resources E.

A manufacturing line P may be provided with an inventory B. The inventory B is also called a buffer stocker and functions as a buffer that absorbs a difference and a variation in the capability of resources E in the manufacturing line P. In FIG. 1, an exemplary configuration is illustrated in which inventories B₂, B₄, and B₅ are included in the process areas S₂, S₄, and S₅, respectively, in the manufacturing line P₁ and inventories B₁₂, B₁₄, and Bis are included in the process areas S₁₂, S₁₄, and S₁₅ in the manufacturing line P₂.

It is based on the premise that the number of lots that can be accommodated in an inventory B is referred to as an inventory capacity, and the number of lots actually accommodated in the inventory B is referred to as an inventory quantity. In FIG. 1, an exemplary configuration is illustrated in which the capacities of the inventories B₂, B₄, B₅, B₁₂, B₁₄, and B₁₅ are three lots, five lots, two lots, one lot, three lots, and one lot, respectively. In FIG. 1, an exemplary state is illustrated in which the inventory quantities of the inventories B₂, B₄, B₅, B₁₂, B₁₄, and B₁₅ are one lot, two lots, one lot, zero lots, one lot, and zero lots, respectively.

Hereinafter, one manufacturing line P will be mainly described; however, other manufacturing lines P are also similar.

In the manufacturing line P, the inflow of lots to resources E and capabilities of the resources E each vary. The inflow of lots corresponds to an arrival rate of lots and indicates the number of lots input towards a resource E per unit time (the number of lots in process). In a case where an inventory B is provided to a resource E, the number of lots input towards the resource E per unit time represents the number of lots input to the inventory B per unit time. In a case where no inventory B is provided to the resource E, the number of lots input towards the resource E per unit time represents the number of lots directly input to the resource E per unit time. The capability of the resource E corresponds to a processing rate of a lot by the resource E and indicates the number of lots that can be processed by the resource E per unit time. The unit time may be one day. The reciprocal of the processing rate represents a processing time of a lot by the resource E. The throughput of the manufacturing line P indicates the number of lots (the number of processing lots) output by the manufacturing line P per unit time.

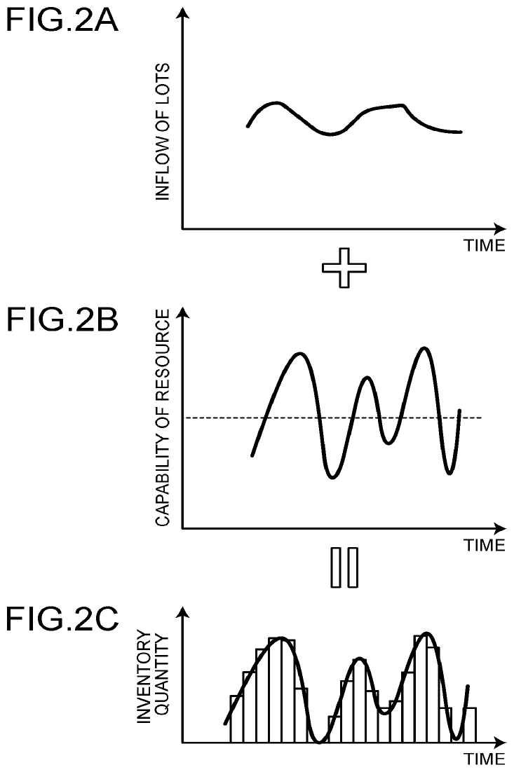

For example, it is based on the premise that the inflow of lots to a resource E in a process area S fluctuates as illustrated in FIG. 2A and that the capacity of the resource E fluctuates as illustrated in FIG. 2B. FIGS. 2A-2C include graphs illustrating fluctuation in the inventory quantity depending on fluctuation in arrival of lots to the resource E and fluctuation in the processing capacity of the resource E. FIG. 2A is a graph illustrating the fluctuation in the arrival of lots to the source. FIG. 2B is a graph illustrating fluctuation in the resource capability. The capability of the resource E illustrated in FIG. 2B corresponds to the processing time of the resource per unit lot.

In this case, based on the premise that the inventory capacity in the process area S is infinite, the inventory quantity held in the inventory fluctuates as illustrated in FIG. 2C. If the actual inventory capacity provided in the process area S is too large with respect to the fluctuation in the inventory quantity illustrated in FIG. 2C, the resource E can be continuously operated; however, the cost of the inventory B may excessively increase. If the capacity of the actual inventory B provided in the process area S is too small with respect to the fluctuation in the inventory quantity illustrated in FIG. 2C, the operation loss of the resource E due to the capacity shortage of the inventory B occurs, and there is a possibility that lots cannot be efficiently processed.

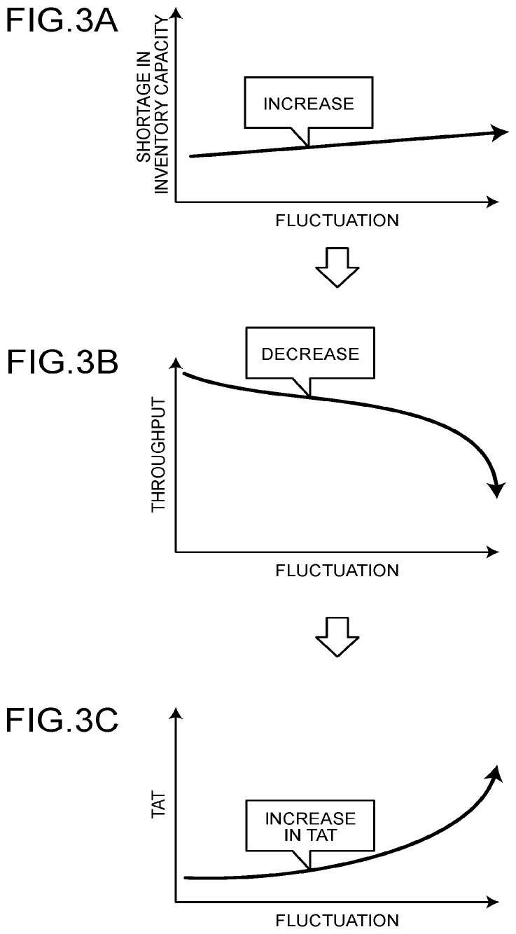

For example, when the fluctuation in the inflow of lots to the resource E and/or the capacity of the resource E increases and the capacity shortage of the inventory B increases as illustrated in FIG. 3A, the inventory B cannot absorb the fluctuation in the inflow of the lots to the resource E and/or the capacity of the resource E, and the operation loss of the resource E may occur. When the operation loss of the resource E occurs, the throughput of the resource E tends to decrease as illustrated in FIG. 3B. When the throughput of the resource E decreases, turn around time (TAT) of a lot increases as illustrated in FIG. 3C, and efficient processing of the lots tends to become difficult.

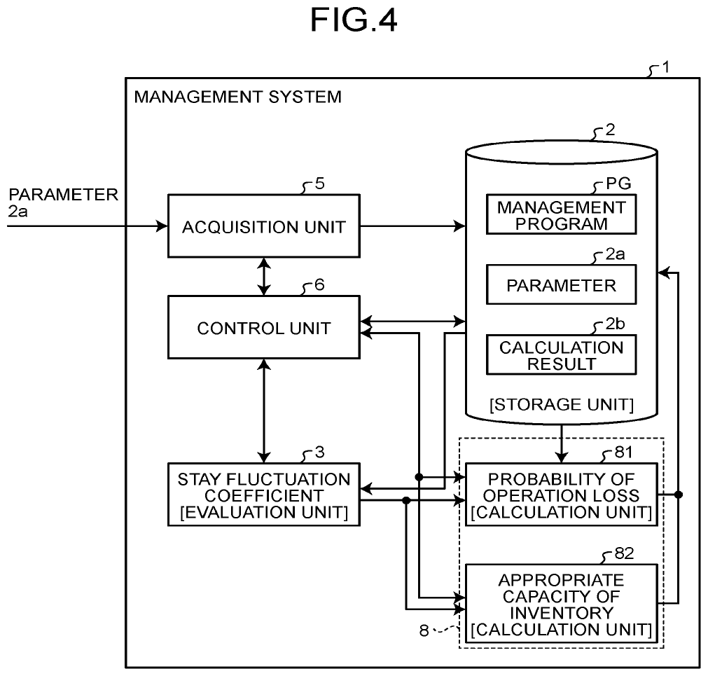

Each manufacturing line P as illustrated in FIGS. 1 to 3C can be managed by a management system 1 as illustrated in FIG. 4. FIG. 4 is a diagram illustrating a functional configuration of the management system 1.

The management system 1 obtains the stay fluctuation characteristic of lots in a process area S on the basis of the arrival fluctuation characteristic of the lots to the process area S and the capability fluctuation characteristic of the process area S. The management system 1 obtains inventory information regarding the inventory to be provided in the process area S depending on the stay fluctuation characteristic of the lots in the process area S. The management system 1 may obtain an appropriate capacity of inventory that enables the resource E in the process area S to continuously operate depending on the stay fluctuation characteristic of the lots in the process area S. The management system 1 may obtain an appropriate capacity of inventory with which the operation loss of the resource E in the process area S becomes zero depending on the stay fluctuation characteristic of the lots in the process area S.

For example, the management system 1 obtains an average processing time tₘ of the resource E on the basis of the capability fluctuation characteristic of the process area S. The management system 1 obtains an occurrence probability P of the operation loss of the resource E in the process area S depending on the stay fluctuation characteristic of the lots in the process area S. As expressed in the following Equation 1, the management system 1 may obtain the number of lots Z as a critical point at which the operation rate of the resource E in the process area S in a period T becomes zero on the basis of the average processing time tₘ of the resource E and the occurrence probability P.

$$Z = \frac{P T}{{t}_{m}} \qquad Equation 1$$

On the basis of the number of lots Z obtained by Equation 1, the management system 1 may set the appropriate capacity of the inventory B to “more than or equal to Z lots”.

The management system 1 includes, as functions, a control unit 6, an acquisition unit 5, a storage unit 2, an evaluation unit 3, a calculation unit 81, and a calculation unit 82.

The storage unit 2 stores a management program PG. The management program PG includes multiple pieces of processing for performing predetermined management. The predetermined management includes management of an appropriate capacity of the inventory with which the operation loss of the resource becomes zero in each process area S.

The control unit 6 integrally controls each of the units of the management system 1 according to the management program PG. The control unit 6 can manage the period T to be processed. The control unit 6 may control each of the units of the management system 1 in such a manner as to perform processing for the period T.

The acquisition unit 5 acquires a parameter 2a under the control of the control unit 6. The parameter 2a includes the number of resources in each process area S of the manufacturing line P, a history of work in progress (WIP), a history of throughput, and the like. The acquisition unit 5 may acquire the parameter 2a in response to input from a user. The acquisition unit 5 may acquire the parameter 2a via a communication medium such as a wired communication line or a wireless communication line.

The storage unit 2 may receive the parameter 2a from the acquisition unit 5 and store the parameter 2a in a database under the control of the control unit 6. The database includes resource information, WIP information, throughput information, and others. The resource information is information in which the number of resources, an identifier of a manufacturing line P, and an identifier of a process area S are associated with each other for multiple manufacturing lines P and multiple process areas S. The WIP corresponds to the number of lots (the number of lots in process) input to a process area S. The WIP information is information in which time information, performance of the number of lots in process, an identifier of a manufacturing line P, and an identifier of a process area S are associated with each other for multiple manufacturing lines P and multiple process areas S. The throughput corresponds to the number of lots (the number of processing lots) output from the process area S. The throughput information is information in which time information, performance of the number of processing lots, an identifier of a manufacturing line P, and an identifier of a process area S are associated with each other for multiple manufacturing lines P and multiple process areas S.

In addition, the storage unit 2 may store a calculation result 2b of the calculation unit 81. The calculation result 2b includes inventory information. The inventory information is information regarding an inventory to be provided in a process area S. The inventory information includes an appropriate capacity of inventory that enables the resource E in the process area S to operate continuously. The inventory information includes an appropriate capacity of the inventory at which the operation loss of the resource E in the process area becomes zero. The inventory information may be information in which the appropriate capacity of the inventory, an identifier of a manufacturing line P, and an identifier of a process area S are associated with each other for multiple manufacturing lines P and multiple process areas S.

The evaluation unit 3 performs evaluation under the control of the control unit 6. The evaluation unit 3 can obtain the stay fluctuation characteristic of lots in a process area S on the basis of the arrival fluctuation characteristic of the lots to the process area S and the capability fluctuation characteristic of the process area S.

For example, the evaluation unit 3 acquires the WIP information for the period T from the storage unit 2. The evaluation unit 3 can specify performance of the number of lots in process in the process area S for each process area S of a manufacturing line P on the basis of the WIP information. For each process area S, the evaluation unit 3 obtains the arrival fluctuation characteristic of lots to the process area S on the basis of the performance of the number of lots in process in the process area S. The evaluation unit 3 analyzes the number of lots in process of each resource E as input for each unit time and obtains the total number of lots in process for multiple resources E in the process area S. The evaluation unit 3 performs statistical processing on multiple unit times to obtain a distribution of the total number of lots in process. The evaluation unit 3 can extract a feature of the distribution (such as the average value or the variance) and use the characteristic as a parameter indicating the arrival fluctuation characteristic of lots to the process area S.

Note that the evaluation unit 3 may further obtain an average arrival time interval tₐ of the process area S for the period T as a parameter indicating the arrival fluctuation characteristic of lots to the process area S. The evaluation unit 3 obtains an arrival time interval of lots to the resource E for each unit time and obtains an average arrival time interval for multiple resources E in the process area S. The evaluation unit 3 time-averages for multiple unit times to obtain the average arrival time interval tₐ.

The evaluation unit 3 acquires the throughput information for the period T from the storage unit 2. The evaluation unit 3 can specify the performance of the number of processing lots in the process area S for each process area S of the manufacturing line P on the basis of the throughput information. For each process area S, the evaluation unit 3 obtains the capability fluctuation characteristic of each resource E in the process area S on the basis of the performance of the number of processing lots in the process area S.

The evaluation unit 3 analyzes the number of processing lots of each resource E as output for each unit time and obtains the total number of processing lots for the multiple resources E in the process area S. The evaluation unit 3 performs statistical processing on multiple unit times to obtain a distribution of the total number of processing lots. The evaluation unit 3 can extract a feature of the distribution (such as the average value or the variance) and use the characteristic as a parameter indicating the capability fluctuation characteristic of the process area S.

Note that the evaluation unit 3 may further obtain the average processing time tₘ of the process area S for the period T as a parameter indicating the capability fluctuation characteristic of the process area S. The evaluation unit 3 obtains a processing time of a lot by the resources E for each unit time and obtains an average processing time for the multiple resources E in the process area S. The evaluation unit 3 time-averages for multiple unit times to obtain the average processing time tₘ.

The evaluation unit 3 acquires WIP information for the period T and the throughput information for the period T from the storage unit 2. The evaluation unit 3 can specify performance of the number of lots in process in the process area S for each process area S of a manufacturing line P on the basis of the WIP information. The evaluation unit 3 can specify the performance of the number of processing lots in the process area S for each process area S of the manufacturing line P on the basis of the throughput information. For each process area S, the evaluation unit 3 obtains the stay fluctuation characteristic of lots in the process area S on the basis of the performance of the number of lots in process and the performance of the number of processing lots in the process area S.

The evaluation unit 3 analyzes, for each unit time, the number of lots in process of each resource E as input, analyzes the number of processing lots of each resource E as output, and analyzes the number of staying lots as a difference. The evaluation unit 3 obtains the total number of staying lots for the multiple resources E in the process area S. The evaluation unit 3 performs statistical processing on multiple unit times to obtain a distribution of the total number of staying lots. The evaluation unit 3 can extract a feature of the distribution (such as the average value or the variance) and use the characteristic as a parameter indicating the stay fluctuation characteristic of the process area S.

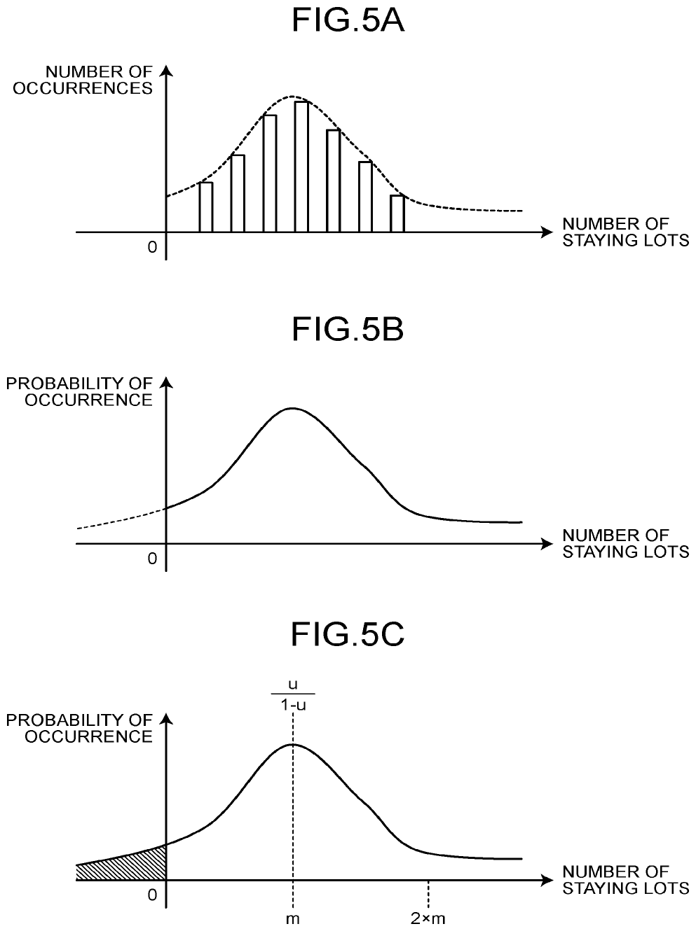

For example, the evaluation unit 3 may obtain a distribution of the number of occurrences of the number of staying lots as illustrated by a bar graph in FIG. 5A as the stay fluctuation characteristic of the lots in the process area S. The evaluation unit 3 obtains an approximate curve as indicated by a dotted line in FIG. 5A with respect to the distribution of the number of occurrences of the number of staying lots.

The evaluation unit 3 may obtain a probability distribution indicated by a solid line in FIG. 5B by converting the vertical axis from the number of occurrences to the occurrence probability in the approximate curve indicated by the dotted line in FIG. 5A. Based on the premise that the probability distribution follows a normal distribution N, the evaluation unit 3 extrapolates a portion where the number of lots is negative as indicated by a dotted line in FIG. 5B. The evaluation unit 3 may extract features (for example, an average value m and a variance σ²) as illustrated in FIG. 5C from the probability distribution after the extrapolation. That is, the evaluation unit 3 may approximate the distribution of occurrence probabilities of the number of staying lots with the normal distribution N (m, σ²). m corresponds to the average value of the probability distribution. σ denotes the standard deviation of the probability distribution. σ² denotes the variance of the probability distribution.

The evaluation unit 3 can obtain a stay fluctuation coefficient c_{q} as expressed in the following Equation 2 as a coefficient representing the fluctuation in the number of staying lots in a process area S.

$${c}_{q} = σ / m \qquad Equation 2$$

As expressed Equation 2, the stay fluctuation coefficient c_{q} is a ratio between the standard deviation σ of the probability distribution and the average number of lots m and indicates the magnitude of fluctuation expressed by normalizing the standard deviation σ with the average number of lots m.

The evaluation unit 3 supplies parameters (for example, the average value m and the variance σ² obtained from the distribution illustrated in FIG. 5C) of the distribution N of the occurrence probabilities of the number of staying lots and the stay fluctuation coefficient c_{q} expressed Equation 2 to the calculation unit 81. The evaluation unit 3 supplies the average processing time tₘ of the resources E to the calculation unit 82.

Note that the evaluation unit 3 may further obtain an average operation rate u of the process area S as a parameter indicating the stay fluctuation characteristic of the process area S. The evaluation unit 3 obtains a cumulative operation time of the resources E for each unit time and obtains an average cumulative operation time of the multiple resources E in the process area S. The evaluation unit 3 time-averages for multiple unit times, divides the obtained value by the period T, and obtains the average operation rate u.

The average operation rate u of a resource E indicates an average ratio of time during which the resource E is operated within the unit time. The average operation rate u of the resource E can also be rephrased as an average load rate of the resource E. The average load rate indicates an average load applied to the resource E in the unit time.

For example, in a case where the operation of the resource E in the process area S can be approximated by an M/M/1 model in the queueing theory, the evaluation unit 3 can obtain the average number of lots m using the average operation rate u of the resource E as expressed in the following Equation 3.

$$m = u / ( 1 - u ) \qquad Equation 3$$

The evaluation unit 3 can obtain the variance σ² using the average operation rate u of the resource E as expressed in the following Equation 4.

$${σ}^{2} = u / {( 1 - u )}^{2} \qquad Equation 4$$

The normal distribution illustrated in FIG. 5C can be expressed by the following Expression 5 on the basis of Equations 3 and 4.

$$N ( \frac{u}{1 - u} , \frac{u}{{( 1 - u )}^{2}} ) \qquad Expression 5$$

With Equations 2, 3, and 4, the evaluation unit 3 may obtain the stay fluctuation coefficient c_{q} as expressed in the following Equation 6.

$${c}_{q} = 1 / √ ( u ) \qquad Equation 6$$

Alternatively, the average operation rate u can be approximated by a ratio between the average arrival time interval tₐ and the average processing time tₘ as expressed Equation 7.

$$u = {t}_{m} / {t}_{a} \qquad Equation 7$$

With Equations 6 and 7, the evaluation unit 3 can obtain the stay fluctuation coefficient c_{q} from Equation 8.

$${c}_{q} = √ ( {t}_{a} / {t}_{m} ) \qquad Equation 8$$

For example, instead of the average value m and the variance σ² obtained from the distribution illustrated in FIG. 5C, the evaluation unit 3 may supply the average value m expressed Equation 3 and the variance σ² expressed Equation 4 to the calculation unit 81. The evaluation unit 3 may supply the stay fluctuation coefficient c_{q} expressed by Equation 6 or Equation 7 to the calculation unit 81 instead of the stay fluctuation coefficient c_{q} expressed by Equation 2.

The calculation unit 81 obtains the occurrence probability P of the operation loss on the basis of parameters (for example, the average value m and the variance σ²) indicating the distribution N of the occurrence probabilities of the number of lots and the stay fluctuation coefficient c_{q}.

Here, it can be estimated that the operation loss of the resource E occurs when the number of staying lots for the resource E is negative as indicated by hatching with oblique lines in FIG. 5C. The calculation unit 81 can obtain the occurrence probability P of the operation loss as an integrated value of the portion indicated by the hatching in FIG. 5C from the following Equation 9.

$$P = {\int }_{- ∞}^{0} N ( m , {σ}^{2} ) d x = \frac{1}{2} [ 1 - Erf ( \frac{1}{{c}_{q} \sqrt{2}} ) ] \qquad Equation 9$$

Equation 9, Erf is an error function and indicates an integrated value in a predetermined range in the normal distribution. Erf(1/{c_{q}√(2)}) represents an integrated value in a range where the number of lots is 0 to 2× m.

Note that, in a case where the operation of the resource E in the process area S can be approximated by the M/M/1 model in the queueing theory, the calculation unit 81 may obtain the occurrence probability P of the operation loss from the following Equation 10.

$$P = {\int }_{- ∞}^{0} N ( m , {σ}^{2} ) d x = \frac{1}{2} [ 1 - Erf ( \sqrt{\frac{{t}_{m}}{2 {t}_{a}}} ) ] \qquad Equation 10$$

The calculation unit 81 supplies the occurrence probability P of the operation loss obtained from Equation 9 or Equation 10 to the calculation unit 82 together with identification information of the process area S.

The calculation unit 82 obtains an appropriate capacity of an inventory B in the process area S on the basis of the average processing time tₘ of the process area S and the occurrence probability P of the operation loss in the process area S.

For example, the calculation unit 82 may obtain the number of lots Z with which the operation rate of the resource E in the process area S in the period T becomes zero as expressed Equation 1 on the basis of the average processing time tₘ of the process area S and the occurrence probability P of the operation loss in the process area S. The occurrence probability P Equation 1 includes the stay fluctuation coefficient c_{q} as expressed Equation 9. As a result, the calculation unit 82 can obtain the number of lots Z with which the operation rate of the resource E in the process area S becomes zero in consideration of the fluctuation (see FIG. 2C) in the inventory quantity corresponding to the fluctuation (see FIG. 2A) in the arrival of lots to the resource E and the fluctuation (see FIG. 2B) in the processing capacity of the resource E.

Alternatively, the calculation unit 82 may use the following Equation 11 obtained by substituting Equation 9 into Equation 1.

$$Z = \frac{T}{2 {t}_{m}} [ 1 - Erf ( \frac{1}{{c}_{q} \sqrt{2}} ) ] \qquad Equation 11$$

The calculation unit 82 may obtain the number of lots Z with which the operation rate of a resource in the process area S in the period T becomes zero from Equation 11 on the basis of the average processing time tₘ of the process area S and the occurrence probability P of the operation loss in the process area S. The number of lots Z expressed Equation 11 includes the stay fluctuation coefficient c_{q}. As a result, the calculation unit 82 can obtain the number of lots Z with which the operation rate of the resource E in the process area S becomes zero in consideration of the fluctuation (see FIG. 2C) in the inventory quantity corresponding to the fluctuation (see FIG. 2A) in the arrival of lots to the resource E and the fluctuation (see FIG. 2B) in the processing capacity of the resource E.

Note that, in a case where the operation of the resource E in the process area S can be approximated by the M/M/1 model in the queueing theory, the calculation unit 82 may use the following Equation 12 obtained by substituting Equation 10 into Equation 1.

$$Z = \frac{T}{2 {t}_{m}} [ 1 - Erf ( \sqrt{\frac{{t}_{m}}{2 {t}_{a}}} ) ] \qquad Equation 12$$

The calculation unit 82 may obtain the number of lots Z with which the operation rate of the resource E in the process area S in the period T becomes zero from the Equation 12 on the basis of the average processing time tₘ of the process area S and the occurrence probability P of the operation loss in the process area S. The number of lots Z expressed Equation 12 includes √(tₐ/tₘ) corresponding to the stay fluctuation coefficient c_{q}. As a result, the calculation unit 82 can obtain the number of lots Z with which the operation rate of the resource in the process area S becomes zero in consideration of the fluctuation (see FIG. 2C) in the inventory quantity corresponding to the fluctuation (see FIG. 2A) in the arrival of lots to the resource E and the fluctuation (see FIG. 2B) in the processing capacity of the resource E.

The calculation unit 82 may set the appropriate capacity of the inventory B in the process area S to “more than or equal to Z lots” on the basis of the number of lots Z obtained by Equation 1, Equation 11, or Equation 12. The calculation unit 82 stores “more than or equal to Z lots” in the storage unit 2 as the calculation result 2b of the appropriate capacity of the inventory B.

Note that the calculation unit 81 and the calculation unit 82 may be configured as a calculation unit 8.

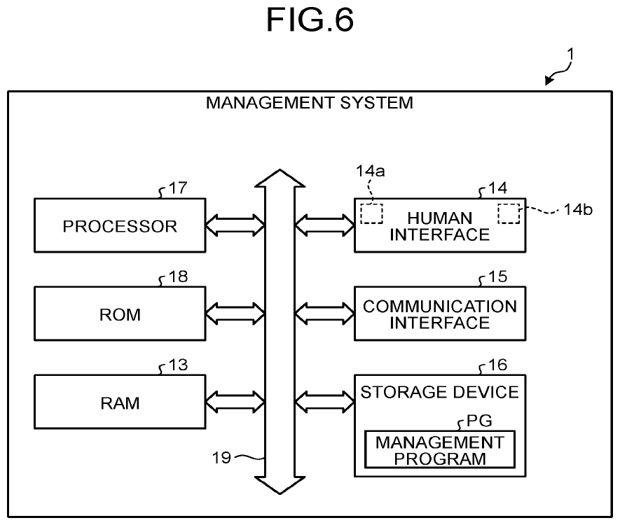

The management system 1 can be implemented by hardware as illustrated in FIG. 6. FIG. 6 is a diagram illustrating a hardware configuration of the management system 1.

The management system 1 includes, as a hardware configuration, a processor 17, a read only memory (ROM) 18, a random access memory (RAN) 13, a human interface 14, a communication interface 15, a storage device 16, and a bus 19.

The processor 17 includes a central processing unit (CPU) and others. The processor 17 corresponds to the control unit 6, the evaluation unit 3, the calculation unit 81, and the calculation unit 82. The control unit 6, the evaluation unit 3, the calculation unit 81, and the calculation unit 82 are loaded on the RAM 13 collectively at the time of compilation or sequentially in accordance with the progress of processing by execution of the management program PG by the processor 17 and are functionally configured.

The ROM 18 stores fixed data. The ROM 18 corresponds to the storage unit 2.

The RAM 13 can temporarily store information and provides a work area or the like to the processor 17. The RAM 13 corresponds to the storage unit 2.

The human interface 14 mediates between a human and the computer. The human interface 14 includes an input device 14a and an output device 14b.

The input device 14a includes a device capable of accepting a request from a human, such as a keyboard, a mouse, and a touch panel. The input device 14a corresponds to the acquisition unit 5.

The output device 14b is a device capable of outputting visual and/or auditory information to a human, such as a display, a printer, a display, and a speaker.

The communication interface 15 can be connected to an external device via a communication medium. When an external device is connected via the communication medium, the communication interface 15 can receive information from the external device or transmit information to the external device.

The storage device 16 is capable of storing information in a nonvolatile manner, such as a hard disk drive (HDD) or a solid state drive (SSD). The storage device 16 stores programs and various types of data for operating the processor 17. The storage device 16 may store the management program PG. The storage device 16 corresponds to the storage unit 2.

The processor 17, the ROM 18, the RAM 13, the human interface 14, the communication interface 15, and the storage device 16 are communicably connected to each other via the bus 19.

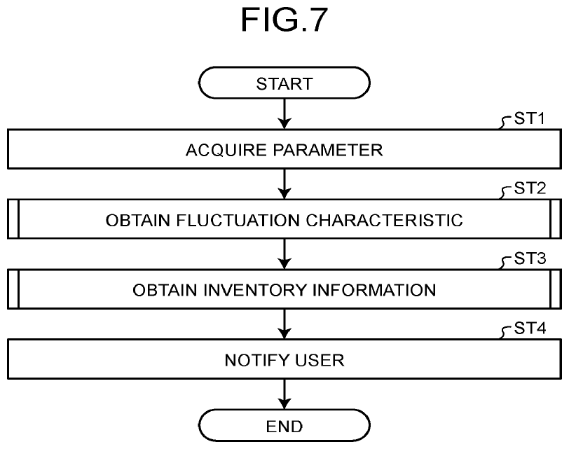

Next, a schematic operation of the management system 1 will be described with reference to FIG. 7. FIG. 7 is a flowchart illustrating a schematic operation of the management system 1.

In the management system 1, the acquisition unit 5 acquires the parameter 2a (ST1). For example, the acquisition unit 5 acquires the parameter 2a in response to input from a user or via a communication medium such as a wired communication line or a wireless communication line. The parameter 2a includes the number of resources in each process area S of the manufacturing line P, the history of WIP, the history of throughput, and others. The storage unit 2 may receive the parameter 2a from the acquisition unit 5 and store the parameter 2a in a database. The database includes resource information, WIP information, throughput information, and others.

The evaluation unit 3 obtains a fluctuation characteristic of the process area S (ST2). The fluctuation characteristic is a characteristic related to fluctuation of lots.

For example, the evaluation unit 3 acquires the WIP information for the period T and the throughput information for the period T from the storage unit 2. The evaluation unit 3 can specify performance of the number of lots in process in the process area S for each process area S of a manufacturing line P on the basis of the WIP information. The evaluation unit 3 can specify the performance of the number of processing lots in the process area S for each process area S of the manufacturing line P on the basis of the throughput information. For each process area S, the evaluation unit 3 obtains the stay fluctuation characteristic of lots in the process area S on the basis of the performance of the number of lots in process and the performance of the number of processing lots in the process area.

The calculation unit 8 obtains the inventory information of the process area S on the basis of the fluctuation characteristics obtained in ST2 (ST3). The inventory information may be related to the inventory B to be provided in the process area S.

For example, the calculation unit 8 may obtain, as the inventory information, an appropriate capacity of inventory that can enables the resource E in the process area S to continuously operate depending on the stay fluctuation characteristic of the lots in the process area S. The calculation unit 8 may obtain, as the inventory information, an appropriate capacity of the inventory B with which the operation loss of the resource E in the process area S becomes zero depending on the stay fluctuation characteristic of the lots in the process area S. The calculation unit 8 supplies the calculation result 2b of the appropriate capacity of the inventory B in each process area S to the storage unit 2. The storage unit 2 stores the calculation result 2b of the appropriate capacity of the inventory B in each process area S.

The control unit 6 notifies the user of the inventory information of each process area S (ST4). For example, the control unit 6 may notify the user of the calculation result 2b of the appropriate capacity of the inventory B in each process area S by a visual and/or auditory means in response to the calculation result 2b having been stored in the storage unit 2, in response to a request from the user, or the like.

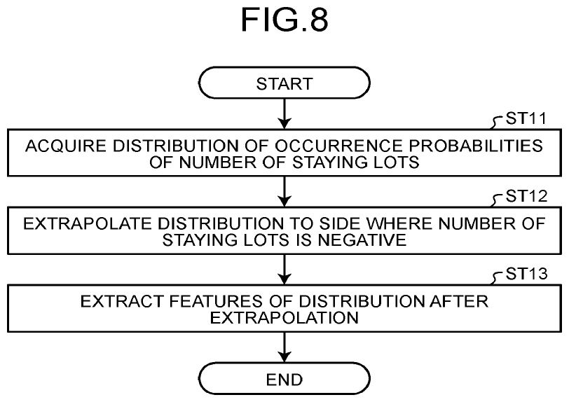

In ST2 illustrated in FIG. 7, ST11 to ST13 illustrated in FIG. 8 may be performed. FIG. 8 is a flowchart illustrating processing (ST2) of obtaining the fluctuation characteristic.

The evaluation unit 3 obtains the distribution of occurrence probabilities of the number of staying lots in the process area S (ST11). For example, the evaluation unit 3 may obtain the distribution of the number of occurrences of the number of staying lots as illustrated by the bar graph in FIG. 5A. The evaluation unit 3 obtains an approximate curve as indicated by a dotted line in FIG. 5A with respect to the distribution of the number of occurrences of the number of staying lots. The evaluation unit 3 may obtain a probability distribution indicated by a solid line in FIG. 5B by converting the vertical axis from the number of occurrences to the occurrence probability in the approximate curve indicated by the dotted line in FIG. 5A.

The evaluation unit 3 extrapolates the distribution obtained in ST11 to the side where the number of staying lots is negative (ST12). For example, based on the premise that the probability distribution obtained in ST11 follows a normal distribution, the evaluation unit 3 extrapolates the portion where the number of lots is negative as indicated by the dotted line in FIG. 5B.

The evaluation unit 3 extracts features of the distribution after the extrapolation (ST13). For example, the evaluation unit 3 may extract a feature (for example, the average value m and the variance σ²) of the probability distribution after the extrapolation. Alternatively, the evaluation unit 3 may acquire the average operation rate u of the resource E in the process area S and obtain the average value m and the variance σ² of the probability distribution by Equations 3 and 4.

The evaluation unit 3 can obtain the stay fluctuation coefficient c_{q} as expressed Equation 2 as a coefficient representing the fluctuation in the number of staying lots in the process area S. Alternatively, the evaluation unit 3 may acquire the average operation rate u of the resource E in the process area S and obtain the stay fluctuation coefficient c_{q} from Equation 6.

The evaluation unit 3 supplies parameters (for example, the average value m and the variance σ²) of the distribution N of the occurrence probabilities of the number of lots and the stay fluctuation coefficient c_{q} to the calculation unit 81.

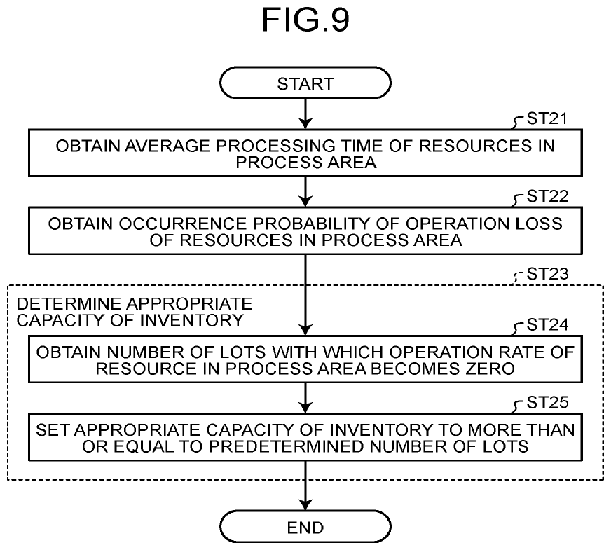

In ST3 illustrated in FIG. 7, ST21 to ST23 illustrated in FIG. 9 may be performed. FIG. 9 is a flowchart illustrating processing (ST3) of obtaining the inventory information.

The evaluation unit 3 obtains the average processing time tₘ of the resources E in the process area S (ST21).

For example, the evaluation unit 3 obtains a processing time of a lot by the resource E for each unit time and obtains an average processing time for the multiple resources E in the process area S. The evaluation unit 3 time-averages for multiple unit times to obtain the average processing time tₘ. The evaluation unit 3 supplies the average processing time tₘ of the resources E in the process area S to the calculation unit 82.

The calculation unit 81 obtains the occurrence probability P of the operation loss on the basis of parameters (for example, the average value m and the variance σ²) indicating the distribution N of the occurrence probabilities of the number of lots and the stay fluctuation coefficient c_{q} (ST22). The calculation unit 81 can obtain the occurrence probability P of the operation loss as an integrated value of the portion indicated by the hatching in FIG. 5C from Equation 9. Alternatively, the calculation unit 81 may obtain the occurrence probability P of the operation loss from Equation 10. The calculation unit 81 supplies the occurrence probability P of the operation loss obtained from Equation 9 or Equation 10 to the calculation unit 82 together with identification information of the process area S.

The calculation unit 82 obtains an appropriate capacity of the inventory B in the process area S on the basis of the average processing time tₘ of the process area S and the occurrence probability P of the operation loss in the process area S (ST23).

In ST23, the following ST24 and ST25 may be performed. For example, the calculation unit 82 obtains the number of lots Z with which the operation rate of the resource in the process area S in the period T becomes zero as expressed Equation 1 on the basis of the average processing time tₘ of the process area S and the occurrence probability P of the operation loss in the process area S (ST24). Alternatively, the calculation unit 82 may obtain the number of lots Z with which the operation rate of a resource in the process area S in the period T becomes zero from Equation 11 on the basis of the average processing time tₘ of the process area S and the occurrence probability P of the operation loss in the process area S. Alternatively, the calculation unit 82 may obtain the number of lots Z with which the operation rate of a resource in the process area S in the period T becomes zero from Equation 12 on the basis of the average processing time tₘ of the process area S and the occurrence probability P of the operation loss in the process area S.

The calculation unit 82 sets the appropriate capacity of the inventory B in the process area S to “more than or equal to Z lots” on the basis of the number of lots Z obtained in ST24 (S25). The calculation unit 82 stores “more than or equal to Z lots” in the storage unit 2 as the calculation result 2b of the appropriate capacity of the inventory B in the process area S.

As described above, in the first embodiment, in the management method for the manufacturing line P, the stay fluctuation characteristic of the lots in the process area S is obtained on the basis of the arrival fluctuation characteristic of the lots to the process area S and the capability fluctuation characteristic of the process area S. For example, the distribution of occurrence probabilities of the number of staying lots is obtained, extrapolation is performed up to the side where the number of staying lots is negative with respect to the distribution, and features of the distribution including the fluctuation coefficient are extracted. Inventory information regarding the inventory B to be provided in the process area S is obtained depending on the stay fluctuation characteristic of the lots in the process area S. For example, the portion where the number of staying lots becomes negative in the extrapolated distribution is integrated using the stay fluctuation coefficient, whereby the number of lots Z with which the operation rate of the resource E in the process area S becomes zero is obtained. Then, the obtained number of lots or more is set as the appropriate capacity of the inventory B. That is, the appropriate capacity of the inventory B is obtained in such a manner that the fluctuation in the arrival of lots to the resource E (see FIG. 2A) and the fluctuation in the inventory quantity (see FIG. 2C) corresponding to the fluctuation in the processing capacity of the resource E (see FIG. 2B) are taken into consideration, and it is possible to notify the user of the appropriate capacity. This makes it possible to prompt the user to provide the inventory B with an appropriate capacity. Therefore, in each manufacturing line P, the operation loss of the resource E in the process area S can be effectively suppressed, and the lots can be efficiently processed.

### Second Embodiment

Next, a management method for a manufacturing line according to a second embodiment will be described. Hereinafter, differences from the first embodiment will be mainly described.

In the first embodiment, the manufacturing line P in which the inventory B can be provided for each process area S is illustrated as an example; however, in the second embodiment, a manufacturing line P in which an inventory B is shared by multiple process areas S is illustrated as an example. A group of multiple process areas S sharing an inventory B will be referred to as an inventory sharing unit U.

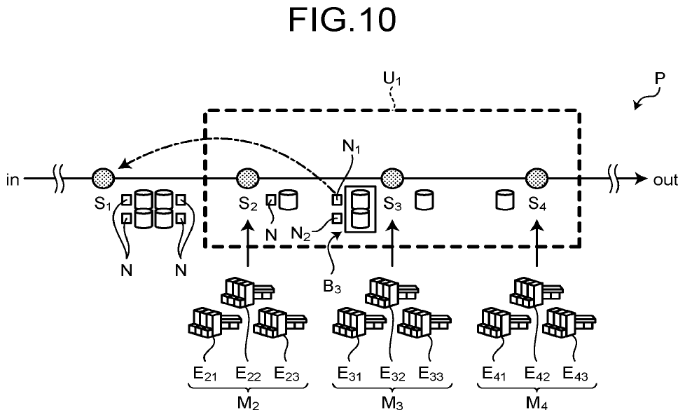

For example, as illustrated in FIG. 10, an inventory sharing unit U₁ may be provided in a manufacturing line P. FIG. 10 is a diagram illustrating a configuration of the manufacturing line P in the second embodiment. The inventory sharing unit U₁ includes multiple process areas S₂ to S₄. The multiple process areas S₂ to S₄ shares an inventory B₃. A constraint time T_{q} is set in the inventory sharing unit U₁. The constraint time T_{q} is a time for assuring quality. The constraint time T_{q} is also referred to as Q-Time. In the manufacturing line P, an average stay time W_{q} of lots in the inventory sharing unit U₁ is managed to be less than or equal to the constraint time T_{q}.

The inventory B₃ may be disposed between the multiple process areas S₂ to S₄ and, for example, may be disposed between the process area S₂ and the process area S₃. In the inventory B₃, a number of signboards N₁ to N₂, the number corresponding to the capacity of the inventory B₃, can be put in place. Each signboard N is associated with a lot from a process area S1 immediately preceding the inventory sharing unit U₁. Once a lot enters the inventory B₃, a signboard N is put in place in the inventory B₃. When a lot is output from the inventory B₃ and input to a resource E, the signboard N is returned to the process area S₁ immediately preceding the inventory sharing unit U₁. A number of lots, the number corresponding to the returned signboard N, are processed in the process area S₁. This makes it possible to instruct the process area S₁ immediately preceding the inventory sharing unit U₁ to perform processing by an amount corresponding to a decrease in the inventory quantity of the inventory B and to replenish the inventory B for the lot processed in the process area S₁ to recover the original inventory quantity. In the manufacturing line P, the upper limit inventory quantity L_{q} of the inventory B₃ is estimated, and the number of signboards, which is the number of signboards N, can be managed to be L_{q} depending on the upper limit inventory quantity L_{q}.

In the process area S₂, resources E₂₁ to E₂₃ are arranged. The resources E₂₁ to E₂₃ are included in a resource group M₂. In the process area S₃, resources E₃₁ to E₃₃ are arranged. The resources E₃₁ to E₃₃ are included in a resource group M₃. In the process area S₄, resources E₄₁ to E₄₃ are arranged. The resources E₄₁ to E₄₃ are included in a resource group M₄.

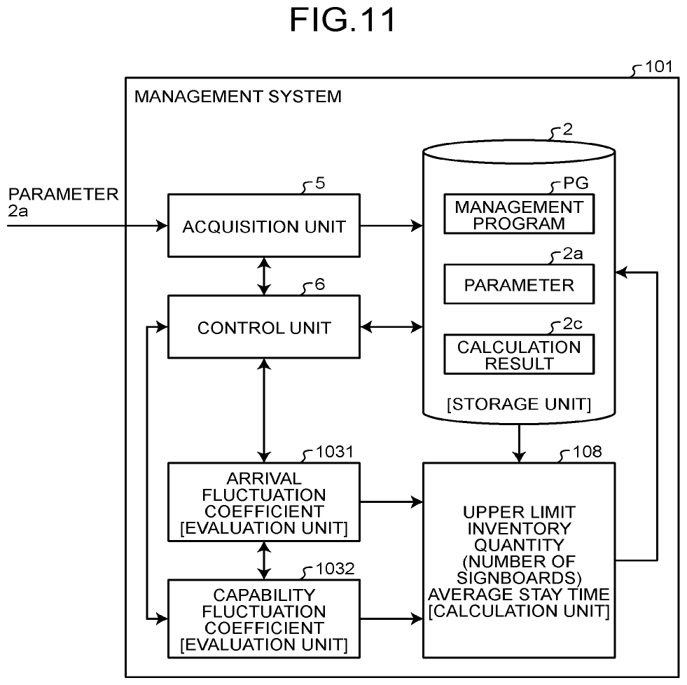

Each manufacturing line P as illustrated in FIG. 10 can be managed by a management system 101 as illustrated in FIG. 11. FIG. 11 is a diagram illustrating a functional configuration of the management system 101.

The management system 101 includes an evaluation unit 1031, an evaluation unit 1032, and a calculation unit 108 instead of the evaluation unit 3 and the calculation unit 8 (see FIG. 4).

The evaluation unit 1031 obtains a parameter indicating an arrival fluctuation characteristic of lots to the inventory sharing unit U and supplies the parameter to the calculation unit 108. The evaluation unit 1032 obtains a parameter indicating a capability fluctuation characteristic of lots of the inventory sharing unit U and supplies the parameter to the calculation unit 108. The calculation unit 108 obtains inventory information using the parameter indicating the arrival fluctuation characteristic of the inventory sharing unit U and the parameter indicating the capability fluctuation characteristic of the inventory sharing unit U. The calculation unit 108 may obtain the upper limit inventory quantity L_{q} of the inventory B of the inventory sharing unit U as the inventory information. The calculation unit 108 may set an appropriate number of signboards as L_{q} depending on the upper limit inventory quantity L_{q} of the inventory B. The calculation unit 108 may obtain the average stay time W_{q} of the inventory sharing unit U by as the inventory information by using the parameter indicating the arrival fluctuation characteristic of the inventory sharing unit U and the parameter indicating the capability fluctuation characteristic of the inventory sharing unit U. The calculation unit 108 may determine whether or not the average stay time W_{q} of the inventory sharing unit U satisfies the constraint time W_{q}.

For example, the evaluation unit 1031 acquires WIP information for a period T from a storage unit 2. The evaluation unit 1031 can specify the performance of the number of lots in process of the inventory sharing unit U on the basis of the WIP information. The evaluation unit 1031 obtains the arrival fluctuation characteristic of lots to the inventory sharing unit U on the basis of the performance of the number of lots in process of the inventory sharing unit U.

The evaluation unit 1031 analyzes the number of lots in process of each of the resources E₂₁ to E₂₃ on the head side as input and obtains the total number of lots in process for the multiple resources E₂₁ to E₂₃ on the head side for each unit time. The evaluation unit 1031 performs statistical processing on multiple unit times to obtain a distribution of the total number of lots in process. The evaluation unit 1031 can extract features of the distribution (for example, the average value mₐ and the variance σₐ²) and use the features as parameters indicating the arrival fluctuation characteristic of lots to the inventory sharing unit U.

The evaluation unit 1031 can obtain an arrival fluctuation coefficient cₐ as expressed in the following Equation 13 as a coefficient representing the fluctuation in the number of lots in process of the inventory sharing unit U.

$${c}_{a} = {σ}_{a} / {m}_{a} \qquad Equation 13$$

As expressed Equation 13, the arrival fluctuation coefficient cₐ is a ratio between a standard deviation σₐ of the probability distribution and the average number of lots mₐ and indicates the magnitude of fluctuation expressed by normalizing the standard deviation σₐ with the average number of lots mₐ.

The evaluation unit 1031 may further obtain an average arrival time interval tₐ of the inventory sharing unit U for the period T as a parameter indicating the arrival fluctuation characteristic of the lots to the inventory sharing unit U. The evaluation unit 1031 obtains an arrival time interval of lots to the resources E₂₁ to E₂₃ on the head side for each unit time and obtains an average arrival time interval for the multiple resources E₂₁ to E₂₃. The evaluation unit 1031 time-averages for multiple unit times to obtain the average arrival time interval tₐ.

The evaluation unit 1031 supplies the parameters of the distribution (for example, the average value mₐ and the variance σₐ²) of the occurrence probabilities of the number of lots in process, the arrival fluctuation coefficient cₐ expressed Equation 13, and the average arrival time interval tₐ to the calculation unit 108.

The evaluation unit 1032 acquires throughput information for the period T from the storage unit 2. The evaluation unit 1032 can specify the performance of the number of processing lots of the inventory sharing unit U on the basis of the throughput information. The evaluation unit 1032 obtains a capability fluctuation characteristic of each of the resources E of the inventory sharing unit U on the basis of the performance of the number of processing lots of the inventory sharing unit U.

The evaluation unit 1032 analyzes the number of processing lots of each of the resources E₄₁ to E₄₃ on the tail side as output for each unit time and obtains the total number of processing lots for the multiple resources E₄₁ to E₄₃. The evaluation unit 1032 performs statistical processing on multiple unit times to obtain a distribution of the total number of processing lots. The evaluation unit 1032 can extract features of the distribution (for example, an average value mₘ and a variance σₘ²) and set the features as parameters indicating the capability fluctuation characteristic of the inventory sharing unit U.

The evaluation unit 1032 can obtain a capability fluctuation coefficient cₘ as expressed in the following Equation 14 as a coefficient representing the fluctuation in the number of processing lots of the inventory sharing unit U.

$${c}_{m} = {σ}_{m} / {m}_{m} \qquad Equation 14$$

As expressed Equation 14, the capability fluctuation coefficient cₘ is a ratio between the standard deviation σₘ of the probability distribution and the average number of lots mₘ and indicates the magnitude of fluctuation expressed by normalizing the standard deviation σₘ with the average number of lots mₘ.

The evaluation unit 1032 may further obtain an average processing time tₘ of the inventory sharing unit U for the period T as a parameter indicating the capability fluctuation characteristic of the inventory sharing unit U. The evaluation unit 1032 obtains a processing time of a lot by each of the resources E₂₁ to E₂₃, E₃₁ to E₃₃, and E₄₁ to E₄₃ for each unit time and obtains an average processing time for the multiple resources E₂₁ to E₂₃, E₃₁ to E₃₃, and E₄₁ to E₄₃ in the inventory sharing unit U. The evaluation unit 1032 time-averages for multiple unit times to obtain the average processing time tₘ.

The evaluation unit 1032 supplies the parameters (for example, the average value mₘ and the variance σₘ²) of the distribution of occurrence probabilities of the number of processing lots, the capability fluctuation coefficient cₘ expressed Equation 14, and the average processing time tₘ to the calculation unit 108.

The calculation unit 108 uses the arrival fluctuation coefficient cₐ of the inventory sharing unit U and the average arrival time interval tₐ of the inventory sharing unit U to obtain a parameter a_{R} representing the average arrival time interval in which the arrival fluctuation is considered from the following Equation 15.

$${a}_{R} = \frac{( 1 + {c}_{a}^{2} ) {t}_{a}}{2} \qquad Equation 15$$

The calculation unit 108 uses the capability fluctuation coefficient cₘ of the inventory sharing unit U and the average processing time tₘ of the inventory sharing unit U to obtain a parameter b_{R} representing the average processing time in which the capability fluctuation is taken into consideration from the following Equation 16.

$${b}_{R} = \frac{( 1 + {c}_{m}^{2} ) {t}_{m}}{2} \qquad Equation 16$$

The calculation unit 108 uses the average arrival time interval tₐ of the inventory sharing unit U and the average processing time tₘ of the inventory sharing unit U to obtain an average operation rate u of the inventory sharing unit U from the following Equation 17.

$$u = \frac{λ {t}_{m}}{k} \qquad Equation 17$$

Equation 17, k denotes the number of resources (nine in the case of FIG. 10) in the inventory sharing unit U. λ denotes an average arrival rate of resources to the inventory sharing unit U and is obtained from the following Equation 18.

$$λ = 1 / {t}_{a} \qquad Equation 18$$

The calculation unit 108 obtains a parameter φ from the following Equation 19 using the average arrival time interval tₐ of the inventory sharing unit U, the average processing time tₘ of the inventory sharing unit U, the parameter a_{R} expressed Equation 15, and the parameter b_{R} expressed Equation 16. The parameter φ is related to a ratio between the average arrival time interval considering the fluctuation and the average processing time considering the fluctuation.

$$∅ = \frac{{b}_{R} - k ( {t}_{a} - {a}_{R} )}{{ka}_{R} + {b}_{R} - {t}_{m}} \qquad Equation 19$$

The calculation unit 108 obtains a probability P^{A}₀ from the following Equation 20 using the average arrival time interval tₐ of the inventory sharing unit U, the average processing time tₘ of the inventory sharing unit U, the parameter a_{R} expressed Equation 15, the parameter b_{R} expressed Equation 16, the average operation rate u expressed Equation 17, and the parameter φ expressed Equation 19. The probability P^{A}₀ is the probability that the number of staying lots in the inventory sharing unit U is zero. The probability P^{A}₀ corresponds to the probability that the inventory quantity of the inventory B₃ is zero.

$${P}_{0}^{A} = \text{} {[ 1 + {\sum }_{m = 1}^{k - 1} {\prod }_{n = 1}^{m} \frac{{t}_{m} - n ( {t}_{a} - {a}_{R} )}{{na}_{R}} + \frac{1 - u {∅}^{r}}{1 - u} \cdot ( λ {a}_{R} - 1 + u ) {\prod }_{n = 1}^{k - 1} \frac{{t}_{m} - n ( {t}_{a} - {a}_{R} )}{{na}_{R}} ]}^{- 1} \qquad Equation 20$$

Equation 20, H denotes the product of an aggregate, and Z denotes the sum of an aggregate. λ denotes the average arrival rate of resources to the inventory sharing unit U, k denotes the number of resources in the inventory sharing unit U, and r denotes the capacity (2 in the case of FIG. 10) of the inventory B₃.

In a case where the number of resources in the inventory sharing unit U is expressed as k=1, the calculation unit 108 may obtain the probability P^{A}₀ by the following Equation 21 in which Equation 20 is simplified.

$${P}_{0}^{A} = {[ 1 + \frac{1 - u {∅}^{r}}{1 - u} \cdot ( λ {a}_{R} - 1 + u ) ]}^{- 1} ( in case of k = 1 ) \qquad Equation 21$$

The calculation unit 108 obtains a probability P^{A}ₖ from the following Equation 22 using the average arrival time interval tₐ of the inventory sharing unit U, the average processing time tₘ of the inventory sharing unit U, the parameter a_{R} expressed Equation 15, the parameter b_{R} expressed Equation 16, and the probability P^{A}₀ expressed Equation 20. The probability P^{A}ₖ is a probability that the number of staying lots in the inventory sharing unit U is k. The probability P^{A}ₖ corresponds to the probability that the inventory quantity of the inventory B₃ is zero.

$${P}_{k}^{A} = {P}_{0}^{A} \frac{1}{( k - 1 ) ! {( {a}_{R} )}^{k - 1}} \cdot \frac{1}{{ka}_{R} + {b}_{R} - {t}_{m}} \cdot {\prod }_{n = 1}^{k} [ {t}_{m} - n ( {t}_{a} - {a}_{R} ) ] \qquad Equation 22$$

Equation 22, Π denotes the product of an aggregate. k denotes the number of resources in the inventory sharing unit U.

The calculation unit 108 obtains a probability P^{A}ₖ₊ᵣ from the following Equation 23 using the average arrival time interval tₐ of the inventory sharing unit U, the average processing time tₘ of the inventory sharing unit U, the parameter a_{R} expressed Equation 15, the parameter φ expressed Equation 19, and the probability P^{A}₀ expressed Equation 20. The probability P^{A}ₖ₊ᵣ is a probability that the number of staying lots in the inventory sharing unit U is k+r. The probability P^{A}ₖ₊ᵣ corresponds to the probability that the inventory quantity of the inventory B₃ is r.

$${P}_{k + r}^{A} = {P}_{0}^{A} \frac{{∅}^{r}}{k ! {{t}_{a} ( {a}_{R} )}^{k - 1}} \cdot {\prod }_{n = 1}^{k} [ {t}_{m} - n ( {t}_{a} - {a}_{R} ) ] \qquad Equation 23$$

Equation 23, Π denotes the product of an aggregate. k denotes the number of resources in the inventory sharing unit U. r denotes the capacity of the inventory B₃.

The calculation unit 108 obtains the upper limit inventory quantity L_{q} of the inventory B₃ by the following Equation 24 using the parameter a_{R} expressed Equation 15, the parameter φ expressed Equation 19, the probability P^{A}ₖ expressed Equation 22, and the probability P^{A}ₖ₊ᵣ expressed Equation 23.

$${L}_{q} = {P}_{k}^{A} [ \frac{1 - ( r + 1 ) {ϕ}^{r} + r {ϕ}^{r + 1}}{{( 1 - ∅ )}^{2}} - λ {a}_{R} \frac{1 - {∅}^{r}}{1 - ∅} ] - {rP}_{k + r}^{A} \qquad Equation 24$$

Equation 24, λ denotes the average arrival rate of resources to the inventory sharing unit U, k denotes the number of resources in the inventory sharing unit U, and r denotes the capacity of the inventory B₃.

The calculation unit 108 sets an appropriate number of signboards as L_{q} depending on the upper limit inventory quantity L_{q} expressed Equation 24. Alternatively, the calculation unit 108 may set the appropriate number of signboards to L_{q}+α depending on the upper limit inventory quantity L_{q} expressed Equation 24. α denotes the number of signboards as a margin.

The calculation unit 108 obtains the average stay time W_{q} of lots in the inventory sharing unit U₁ from the following Equation 25 using the probability P^{A}ₖ₊ᵣ expressed Equation 23 and the upper limit inventory quantity L_{q} expressed Equation 24 on the basis of the Little's law.

$${W}_{q} = \frac{{L}_{q}}{λ ( 1 - {P}_{k + r}^{A} )} \qquad Equation 25$$

Equation 25, λ denotes an average arrival rate of resources to the inventory sharing unit U.

Note that the constraint time T_{q} may be set in the calculation unit 108. The calculation unit 108 may determine whether or not the average stay time W_{q} satisfies the constraint time T_{q}.

The calculation unit 108 stores calculation results 2c including the upper limit inventory quantity L_{q} of the inventory B₃, the appropriate number of signboards L_{q} (or L_{q}+α), and the average stay time W_{q} in the storage unit 2. Alternatively, the calculation unit 108 stores the calculation results 2c including the upper limit inventory quantity L_{q} of the inventory B₃, the appropriate number of signboards L_{q} (or L_{q}+α), the average stay time W_{q}, and a determination result of the constraint time in the storage unit 2.

In addition, the operation of the management system 1 is different from that of the first embodiment in the following points.

In ST2 illustrated in FIG. 7, the evaluation units 1031 and 1032 and the calculation unit 108 obtain the stay fluctuation characteristic of lots of the inventory sharing unit U.

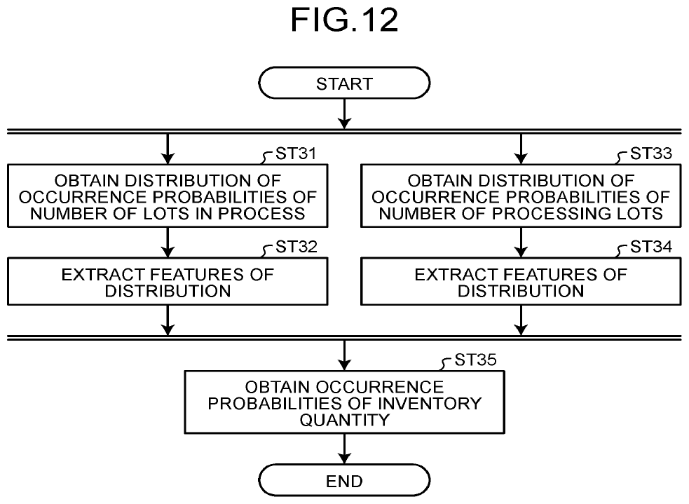

For example, in ST2, ST31 to ST35 illustrated in FIG. 12 may be performed. ST31 to ST32 and ST33 to ST34 can be performed in parallel with each other.

In ST31 to ST32, the evaluation unit 1031 acquires WIP information for the period T from the storage unit 2. The evaluation unit 1031 can specify the performance of the number of lots in process of the inventory sharing unit U on the basis of the WIP information. The evaluation unit 1031 obtains the arrival fluctuation characteristic of lots to the inventory sharing unit U on the basis of the performance of the number of lots in process of the inventory sharing unit U.

In ST31, the evaluation unit 1031 obtains a distribution of occurrence probabilities of the number of lots in process. For example, the evaluation unit 1031 acquires WIP information for a period T from a storage unit 2. The evaluation unit 1031 can specify the performance of the number of lots in process of the inventory sharing unit U on the basis of the WIP information. The evaluation unit 1031 obtains the arrival fluctuation characteristic of lots to the inventory sharing unit U on the basis of the performance of the number of lots in process of the inventory sharing unit U. The evaluation unit 1031 analyzes the number of lots in process of each of the resources E₂₁ to E₂₃ on the head side as input and obtains the total number of lots in process for the multiple resources E₂₁ to E₂₃ on the head side for each unit time. The evaluation unit 1031 performs statistical processing on multiple unit times to obtain a distribution of the total number of lots in process.

In ST32, the evaluation unit 1031 can extract features of the distribution (for example, the average value mₐ and the variance σₐ²) obtained in ST31 and use the features as parameters indicating the arrival fluctuation characteristic of lots to the inventory sharing unit U.

The evaluation unit 1031 can obtain the arrival fluctuation coefficient cₐ as expressed Equation 13 as a coefficient representing the fluctuation in the number of lots in process of the inventory sharing unit U.

The evaluation unit 1031 may further obtain an average arrival time interval tₐ of the inventory sharing unit U for the period T as a parameter indicating the arrival fluctuation characteristic of the lots to the inventory sharing unit U. The evaluation unit 1031 obtains an arrival time interval of lots to the resources E₂₁ to E₂₃ on the head side for each unit time and obtains an average arrival time interval for the multiple resources E₂₁ to E₂₃. The evaluation unit 1031 time-averages for multiple unit times to obtain the average arrival time interval tₐ.

The evaluation unit 1031 supplies the parameters of the distribution (for example, the average value mₐ and the variance σₐ²) of the occurrence probabilities of the number of lots in process, the arrival fluctuation coefficient cₐ expressed Equation 13, and the average arrival time interval tₐ to the calculation unit 108.

In ST33 to ST34, the evaluation unit 1032 acquires throughput information for the period T from the storage unit 2. The evaluation unit 1032 can specify the performance of the number of processing lots of the inventory sharing unit U on the basis of the throughput information. The evaluation unit 1032 obtains a capability fluctuation characteristic of each of the resources E of the inventory sharing unit U on the basis of the performance of the number of processing lots of the inventory sharing unit U.

In ST33, the evaluation unit 1032 obtains a distribution of occurrence probabilities of the number of processing lots. For example, the evaluation unit 1032 acquires the throughput information for the period T from the storage unit 2. The evaluation unit 1032 can specify the performance of the number of processing lots of the inventory sharing unit U on the basis of the throughput information. The evaluation unit 1032 obtains a capability fluctuation characteristic of each of the resources E of the inventory sharing unit U on the basis of the performance of the number of processing lots of the inventory sharing unit U.

The evaluation unit 1032 analyzes the number of processing lots of each of the resources E₄₁ to E₄₃ on the tail side as output for each unit time and obtains the total number of processing lots for the multiple resources E₄₁ to E₄₃. The evaluation unit 1032 performs statistical processing on multiple unit times to obtain a distribution of the total number of processing lots.

In ST34, the evaluation unit 1032 can extract features (for example, the average value mₘ and the variance σₘ²) of the distribution obtained in ST33 and set the features as parameters indicating the capability fluctuation characteristic of the inventory sharing unit U.

The evaluation unit 1032 can obtain the capability fluctuation coefficient cₘ as expressed in the Equation 14 as a coefficient representing the fluctuation in the number of processing lots of the inventory sharing unit U.

The evaluation unit 1032 may further obtain an average processing time tₘ of the inventory sharing unit U for the period T as a parameter indicating the capability fluctuation characteristic of the inventory sharing unit U. The evaluation unit 3 obtains a processing time of a lot by each of the resources E₂₁ to E₂₃, E₃₁ to E₃₃, and E₄₁ to E₄₃ for each unit time and obtains an average processing time for the multiple resources E₂₁ to E₂₃, E₃₁ to E₃₃, and E₄₁ to E₄₃ in the inventory sharing unit U. The evaluation unit 3 time-averages for multiple unit times to obtain the average processing time tₘ.

The evaluation unit 1032 supplies the parameters (for example, the average value mₘ and the variance σₘ²) of the distribution of occurrence probabilities of the number of processing lots, the capability fluctuation coefficient cₘ expressed Equation 14, and the average processing time tₘ to the calculation unit 108.

In ST35, when acquisition of the parameter indicating the arrival fluctuation characteristic from the evaluation unit 1031 and acquisition of the parameter indicating the capability fluctuation characteristic from the evaluation unit 1032 are completed, the calculation unit 108 obtains the stay fluctuation characteristic of the inventory sharing unit U using these parameters. The calculation unit 108 may obtain the distribution of occurrence probabilities of the inventory quantity in the inventory sharing unit U as the stay fluctuation characteristic of the inventory sharing unit U.

The calculation unit 108 uses the arrival fluctuation coefficient cₐ of the inventory sharing unit U and the average arrival time interval tₐ of the inventory sharing unit U to obtain the parameter a_{R} representing the average arrival time interval in which the arrival fluctuation is considered from Equation 15.

The calculation unit 108 uses the capability fluctuation coefficient cₘ of the inventory sharing unit U and the average processing time tₘ of the inventory sharing unit U to obtain a parameter b_{R} representing the average processing time in which the capability fluctuation is taken into consideration from Equation 16.

The calculation unit 108 uses the average arrival time interval tₐ of the inventory sharing unit U and the average processing time tₘ of the inventory sharing unit U to obtain an average operation rate u of the inventory sharing unit U from Equation 17.

The calculation unit 108 obtains a parameter φ from Equation 19 using the average arrival time interval ta of the inventory sharing unit U, the average processing time tₘ of the inventory sharing unit U, the parameter a_{R}expressed Equation 15, and the parameter b_{R} expressed Equation 16.

The calculation unit 108 obtains a probability P^{A}₀ from Equation 20 using the average arrival time interval tₐ of the inventory sharing unit U, the average processing time tₘ of the inventory sharing unit U, the parameter a_{R} expressed Equation 15, the parameter b_{R} expressed Equation 16, the average operation rate u expressed Equation 17, and the parameter φ expressed Equation 19. The probability P^{A}₀ is the probability that the number of staying lots in the inventory sharing unit U is zero. The probability P^{A}₀ corresponds to the probability that the inventory quantity of the inventory B₃ is zero.

The calculation unit 108 obtains a probability P^{A}ₖ from Equation 22 using the average arrival time interval tₐ of the inventory sharing unit U, the average processing time tₘ of the inventory sharing unit U, the parameter a_{R} expressed Equation 15, the parameter b_{R} expressed Equation 16, and the probability P^{A}₀ expressed Equation 20. The probability P^{A}ₖ is a probability that the number of staying lots in the inventory sharing unit U is k. The probability P^{A}ₖ corresponds to the probability that the inventory quantity of the inventory B₃ is zero.

The calculation unit 108 obtains a probability P^{A}ₖ₊ᵣ from the Equation 23 using the average arrival time interval tₐ of the inventory sharing unit U, the average processing time tₘ of the inventory sharing unit U, the parameter a_{R} expressed Equation 15, the parameter φ expressed Equation 19, and the probability P^{A}₀ expressed Equation 20. The probability P^{A}ₖ₊ᵣ is a probability that the number of staying lots in the inventory sharing unit U is k+r. The probability P^{A}ₖ₊ᵣ corresponds to the probability that the inventory quantity of the inventory B₃ is r.

In ST3 illustrated in FIG. 7, the calculation unit 108 obtains inventory information of the inventory sharing unit U on the basis of the stay fluctuation characteristic of the inventory sharing unit U obtained in ST2.

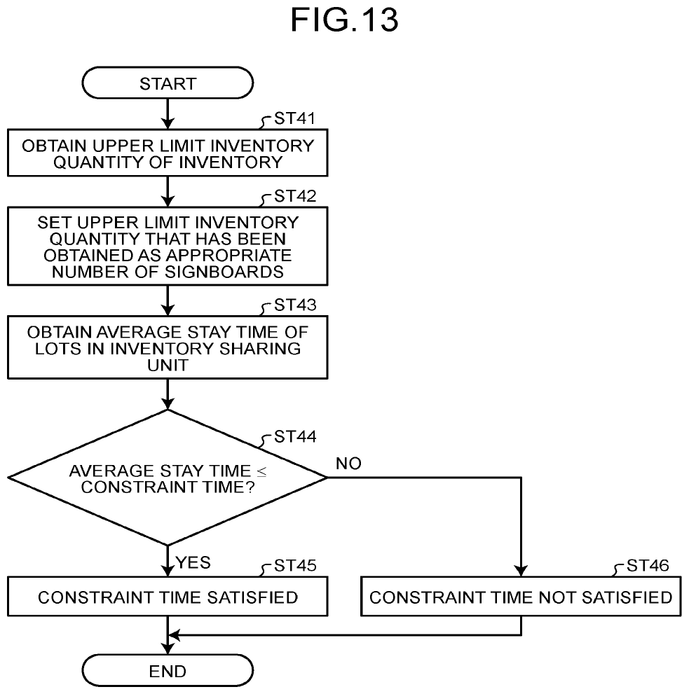

For example, in ST3, ST41 to ST46 illustrated in FIG. 13 may be performed.

In ST41, the calculation unit 108 obtains the upper limit inventory quantity L_{q} of the inventory B₃ from Equation 24 using the parameter a_{R} expressed Equation 15, the parameter φ expressed Equation 19, the probability P^{A}ₖ expressed Equation 22, and the probability P^{A}ₖ₊ᵣ expressed Equation 23.

In ST42, the calculation unit 108 sets an appropriate number of signboards as L_{q} depending on the upper limit inventory quantity L_{q} expressed Equation 24. Alternatively, the calculation unit 108 may set the appropriate number of signboards to L_{q}+a depending on the upper limit inventory quantity L_{q} expressed Equation 24. α denotes the number of signboards as a margin.

In ST43, the calculation unit 108 obtains the average stay time W_{q} of lots in the inventory sharing unit U₁ from Equation 25 using the probability P^{A}ₖ₊ᵣ expressed Equation 23 and the upper limit inventory quantity L_{q} expressed Equation 24 on the basis of the Little's law.

In ST44, the calculation unit 108 compares the average stay time W_{q} with the constraint time T_{q} and determines whether or not the average stay time W_{q} is less than or equal to the constraint time T_{q}.

If the average stay time W_{q} is less than or equal to the constraint time T_{q} (Yes in S44), the calculation unit 108 determines that the inventory sharing unit U satisfies the constraint time (S45). The calculation unit 108 stores, in the storage unit 2, the calculation results 2c including the upper limit inventory quantity L_{q} of the inventory B₃, the appropriate number of signboards L_{q} (or L_{q}+α), the average stay time W_{q}, and a determination result that the constraint time is satisfied.

If the average stay time W_{q} exceeds the constraint time T_{q} (No in S44), the calculation unit 108 determines that the inventory sharing unit U does not satisfy the constraint time (S46). The calculation unit 108 stores, in the storage unit 2, the calculation results 2c including the upper limit inventory quantity L_{q} of the inventory B₃, the appropriate number of signboards L_{q} (or L_{g}+α), the average stay time W_{q}, and a determination result that the constraint time is not satisfied.

As described above, in the second embodiment, in the management method for the manufacturing line P, the stay fluctuation characteristic of the lots in the inventory sharing unit U is obtained on the basis of the arrival fluctuation characteristic of the lots to the inventory sharing unit U and the capability fluctuation characteristic of the inventory sharing unit U. For example, the occurrence probability of the inventory quantity in an inventory B of the inventory sharing unit U is obtained using the arrival fluctuation coefficient and the capability fluctuation coefficient. The upper limit inventory quantity L_{q} of the inventory B₃ and the appropriate number of signboards L_{q} are obtained depending on the stay fluctuation characteristic of the lots in the inventory sharing unit U. That is, the upper limit inventory quantity L_{q} of the inventory B₃ and the appropriate number of signboards L_{q} (or L_{g}+α) are obtained in consideration of the fluctuation in the inventory quantity depending on the fluctuation in the arrival of lots to the inventory sharing unit U and the fluctuation in the processing capacity of the inventory sharing unit U, and these can be notified to the user. As a result, it is possible to suppress a theoretically impossible number of signboards from being set, to reduce the load of signboards management, and to flexibly set the number of signboards in association with and/or according to a distribution among preceding and subsequent processes. As a result, the lots can be efficiently processed in the manufacturing line P.

In addition, in the second embodiment, in the management method for the manufacturing line P, the average stay time W_{q} of the lots in the inventory sharing unit U is obtained depending on the stay fluctuation characteristic of the lots in the inventory sharing unit U. That is, the average stay time W_{q} of the lots is obtained in consideration of the fluctuation in the inventory quantity corresponding to the fluctuation in the arrival of the lots to the inventory sharing unit U and the fluctuation in the processing capacity of the inventory sharing unit U, and the determination result as to whether or not the average stay time W_{q} satisfies the constraint time T_{q} can be notified to the user. Accordingly, in a case where the constraint time of the inventory sharing unit U is not substantially satisfied, it is possible to prompt the user to perform improvement for increasing the capacity of the inventory B to satisfy the constraint time T_{q}. As a result, the lots can be appropriately and efficiently processed in the manufacturing line P.

### Third Embodiment

Next, a management method for a manufacturing line according to a third embodiment will be described. Hereinafter, differences from the first embodiment and the second embodiment will be mainly described.

In the first embodiment, the management of the manufacturing line P focusing on the flow of lots for each process area S has been illustrated as an example; however, in the third embodiment, management of a manufacturing line P focusing on the flow of lots in multiple process areas S that are reenterable is illustrated as an example.

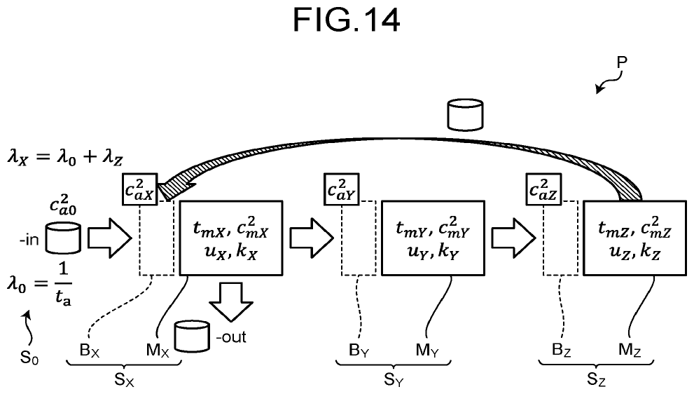

For example, as illustrated in FIG. 14, multiple reenterable process areas S_{X} to S_{Z} may be included in the manufacturing line P. FIG. 14 is a diagram illustrating a configuration of the manufacturing line P in the third embodiment.

In each of the multiple reenterable process areas S_{X} to S_{Z}, the same resource E may perform repetitive processing on the same lot. The repetitive processing may be performed with different recipes (processing conditions). In the manufacturing line P, as indicated by an arrow in FIG. 14, a lot is input from an immediately preceding process area S₀ to the process area S_{X} in the head. When processing is sequentially performed by the resource E in the order of process area S_{X}->process area S_{Y}->process area S_{Z}, the lot returns to the process area S_{X} to be processed again by the resource E in the process area S_{X} and is carried out to a process area S (not illustrated) of a subsequent stage. A group of resources E in the multiple reenterable process areas S_{X} to S_{Z} is also referred to as a job shop.

Each of the process areas S_{X} to S_{Z} has an inventory B and a resource group M. The process area S_{X} has an inventory B_{X} and a resource group M_{X}. The resource group M_{X} includes k_{X} resources E. The process area S_{Y} has an inventory B_{Y} and a resource group M_{Y}. The resource group M_{Y} includes k_{Y} resources E. The process area S_{Z} has an inventory B_{Z} and a resource group M_{Z}. The resource group M_{Z} includes k_{Z} resources E.

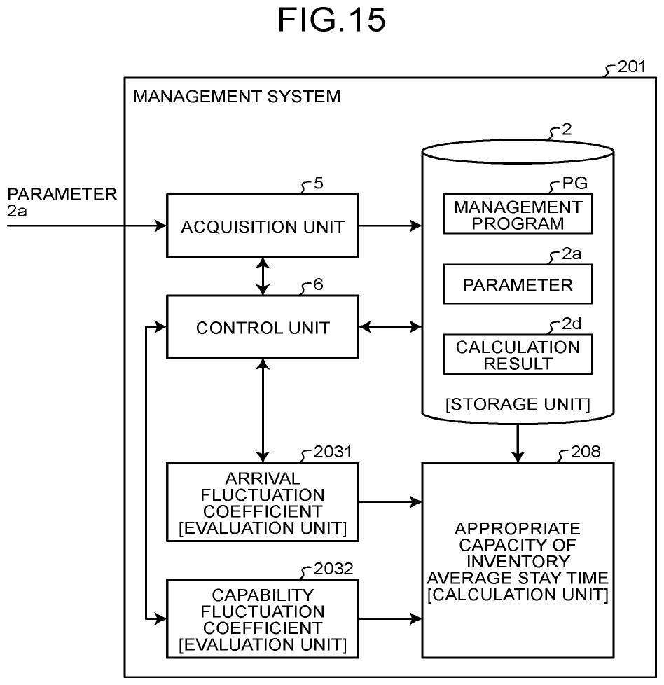

Each manufacturing line P as illustrated in FIG. 14 can be managed by a management system 201 as illustrated in FIG. 15. FIG. 15 is a diagram illustrating a functional configuration of the management system 201.

The management system 201 includes an evaluation unit 2031, an evaluation unit 2032, and a calculation unit 208 instead of the evaluation unit 3 and the calculation unit 8 (see FIG. 4).

The evaluation unit 2031 obtains a parameter indicating an arrival fluctuation characteristic of lots in each of the reenterable process areas S_{X} to S_{Z} and supplies the parameter to the calculation unit 208. The evaluation unit 2032 obtains a parameter indicating a capability fluctuation characteristic of each of the reenterable process areas S_{X} to S_{Z} and supplies the parameter to the calculation unit 208. The calculation unit 208 obtains inventory information by using the parameters indicating the arrival fluctuation characteristics of the process areas S_{X} to S_{Z} and the parameters indicating the capability fluctuation characteristics of the process areas S_{X} to S_{Z}. The calculation unit 208 may obtain upper limit inventory quantities L_{X} to L_{Z} of the inventories B in the process areas S_{X} to S_{Z}, respectively, as the inventory information. The calculation unit 208 may set appropriate capacities of the inventories B to L_{X} to L_{Z} depending on the upper limit inventory quantities L_{X} to L_{Z}, respectively, of the inventories B. The calculation unit 208 may obtain average stay times W_{X} to W_{Z} of the process areas S_{X} to S_{Z} as the inventory information by using the parameters indicating the arrival fluctuation characteristics of the process areas S_{X} to S_{Z} and the parameters indicating the capability fluctuation characteristics of the process areas S_{X} to S_{Z}. The average stay times W_{X} to W_{Z} each correspond to a time a lot stays in an inventory B.

For example, the evaluation unit 2031 acquires WIP information regarding a predetermined period from a storage unit 2. The evaluation unit 2031 can specify performance of the number of lots in process in each of the process areas S_{X} to S_{Z} on the basis of the WIP information. The evaluation unit 2031 obtains an arrival fluctuation characteristic of lots to the process areas S_{X} to S_{Z} on the basis of performance of the number of lots in process in the process areas S_{X} to S_{Z}, respectively.

The evaluation unit 2031 may obtain average arrival time intervals t_{aX} to t_{aZ} of the process areas S_{X} to S_{Z} for the predetermined period as parameters indicating arrival fluctuation characteristics of lots in the process areas S_{X} to S_{Z}, respectively. The evaluation unit 2031 obtains an arrival time interval of lots to a resource E in each of the process areas S_{X} to S_{Z} for each unit time and obtains an average arrival time interval for multiple resources E. The evaluation unit 2031 time-averages for multiple unit times to obtain the average arrival time intervals t_{aX} to t_{aZ} of the process areas S_{X} to S_{Z}, respectively. The evaluation unit 2031 obtains average arrival rates λ_{X} to λ_{Z} as the reciprocals of the average arrival time intervals t_{aX} to t_{aZ} of the process areas S_{X} to S_{Z}, respectively.

Note that the evaluation unit 2031 may obtain the average arrival rates λ_{X} to λ_{Z} of the process areas S_{X} to S_{Z} by the following Equations 26 from an average arrival rate λ₀ of the process area S₀ immediately preceding the multiple reenterable process areas S_{X} to S_{Z}.

$$\cdot {λ}_{i} … \{ \begin{matrix}\cdot {λ}_{X} = {λ}_{0} + {λ}_{Z} \\ \cdot {λ}_{Y} = \frac{{λ}_{0}}{{λ}_{0} + {λ}_{Z}} {λ}_{X} \\ \cdot {λ}_{Y} = {λ}_{Z} = {λ}_{0}\end{matrix} \qquad Equation 26$$

The evaluation unit 2031 supplies the average arrival time intervals t_{aX} to t_{aZ} to the evaluation unit 2032.

The evaluation unit 2032 acquires throughput information for the predetermined period from the storage unit 2. The evaluation unit 2032 can specify the performance of the number of processing lots in each of the process areas S_{X} to S_{Z} on the basis of the throughput information. The evaluation unit 2032 obtains a capability fluctuation characteristic of each resource E in the process areas S_{X} to S_{Z} on the basis of the performance of the number of processing lots in the process area S_{X} to S_{Z}, respectively.

The evaluation unit 2032 may further obtain average processing times t_{mX} to t_{mZ} of the process areas S_{X} to S_{Z} for the predetermined period as parameters indicating the capability fluctuation characteristics of the process areas S_{X} to S_{Z}, respectively. The evaluation unit 2032 obtains a processing time of a lot by each resource E for each unit time and obtains an average processing time for multiple resources E in each of the process areas S_{X} to S_{Z}. The evaluation unit 2032 time-averages for multiple unit times to obtain the average processing times t_{mX} to t_{mZ} of the process areas S_{X} to S_{Z}, respectively.

The evaluation unit 2032 acquires number-of-resources information from the storage unit 2 and specifies the number of resources k_{X} to k_{Z} of the process areas S_{X} to S_{Z}, respectively, according to the number-of-resources information. The evaluation unit 2032 acquires the average arrival time intervals t_{aX} to t_{aZ} from the evaluation unit 1031. The evaluation unit 2032 may obtain average operation rates uX to uZ of the process areas S_{X} to S_{Z} from the following Equations 27 using the average processing times t_{mX} to t_{mZ}, the average arrival time intervals t_{aX} to t_{aZ}, and the number of resources k_{X} to k_{Z}.

$$\cdot {u}_{i} = \frac{{t}_{mi}}{{k}_{i}} {λ}_{i} … \{ \begin{matrix}\cdot {u}_{X} = \frac{{t}_{mX}}{{t}_{a} \cdot {k}_{X}} \\ \cdot {u}_{Y} = \frac{{t}_{mY}}{{t}_{a} \cdot {k}_{Y}} \\ \cdot {u}_{Z} = \frac{{t}_{mZ}}{{t}_{a} \cdot {k}_{Z}}\end{matrix} \qquad Equation 27$$

The evaluation unit 2032 analyzes the number of processing lots of each resource E as output for each of the process areas S_{X} to S_{Z} for each unit time and obtains the total number of processing lots for the multiple resources E. The evaluation unit 2032 performs statistical processing on multiple unit times to obtain a distribution of the total number of processing lots. The evaluation unit 2032 can extract features (for example, average values m_{mX} to m_{mZ} and the variances σmX² to o_{mZ}²) of the distributions for the process areas S_{X} to S_{Z} and use the features as parameters indicating capability fluctuation characteristics of the process areas S_{X} to S_{Z}, respectively.

The evaluation unit 2032 can obtain capability fluctuation coefficients c_{mX} to c_{mZ} as expressed in the following Equations 28 as coefficients representing fluctuations in the number of processing lots in the process areas S_{X} to S_{Z}, respectively.

$${c}_{mX} = {σ}_{mX} / {m}_{mX} , {c}_{mY} = {σ}_{mY} / {m}_{mY} , {c}_{mZ} = {σ}_{mZ} / {m}_{mZ} \qquad Equation 28$$

The evaluation unit 2032 supplies the average operation rates u_{X} to u_{Z}, the average processing times t_{mX} to t_{mZ}, and the capability fluctuation coefficients c_{mX} to c_{mZ} to each of the evaluation unit 2031 and the calculation unit 208.

The evaluation unit 2031 acquires the number-of-resources information from the storage unit 2 and specifies the number of resources k_{X} to k_{Z} of the process areas S_{X} to S_{Z}, respectively, according to the number-of-resources information. The evaluation unit 2031 acquires the average operation rates u_{X} to u_{Z} and the capability fluctuation coefficients c_{mX} to c_{mZ} from the evaluation unit 2032. The evaluation unit 2031 may use the number of resources k_{X} to k_{Z}, the average arrival rates λ_{X} to λ_{Z}, the average operation rates u_{X} to u_{Z}, and the capability fluctuation coefficients c_{mX} to c_{mZ} to obtain arrival fluctuation coefficients c_{aX} to c_{aZ} as expressed in the following Equations 29 to 31.

$${c}_{aZ}^{2} = ( 1 - {u}_{Y}^{2} ) {c}_{aY}^{2} + {u}_{Y}^{2} \frac{{c}_{mY}^{2} + \sqrt{{k}_{Y}} - 1}{\sqrt{{k}_{Y}}} \qquad Equation 29$$

$${c}_{aY}^{2} = {p}_{Y} {c}_{aX}^{2} + 1 - {p}_{Y} , \qquad Equation 30$$

$${p}_{Y} = {λ}_{0} / ( {λ}_{0} + {λ}_{z} ) ,$$

$${c}_{dX}^{2} = ( 1 - {u}_{X}^{2} ) {c}_{aX}^{2} + {u}_{X}^{2} \frac{{c}_{mX}^{2} + \sqrt{{k}_{X}} - 1}{\sqrt{{k}_{X}}}$$

$${c}_{aX}^{2} = ( {λ}_{0} {c}_{a 0}^{2} + {λ}_{Z} {c}_{dZ}^{2} ) / ( {λ}_{0} + {λ}_{z} ) , \qquad Equation 31$$

$${c}_{dZ}^{2} = ( 1 - {u}_{Z}^{2} ) {c}_{aZ}^{2} + {u}_{Z}^{2} \frac{{c}_{mZ}^{2} + \sqrt{{k}_{Z}} - 1}{\sqrt{{k}_{Z}}}$$

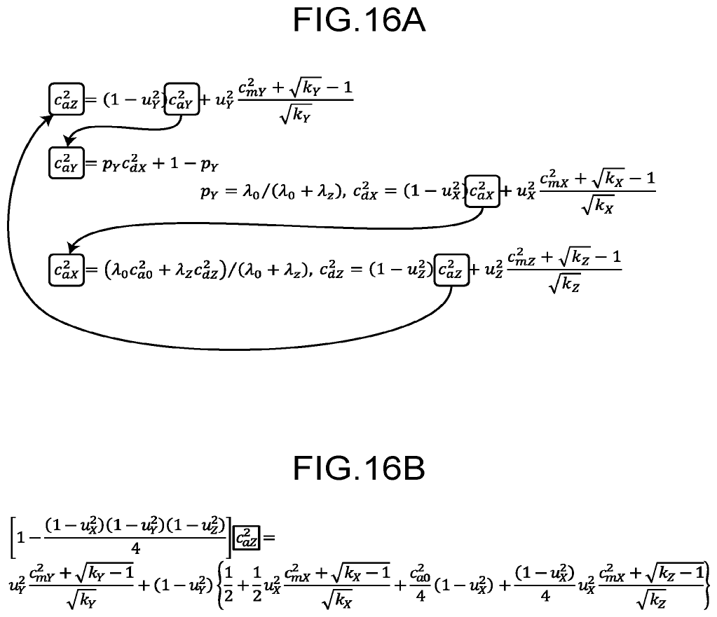

Incidentally, Equations 29 to 31 correspond to the flow of lots in the multiple reenterable process areas S_{X} to S_{Z}. Therefore, Equations 29 to 31 are subjected to circular reference as indicated by arrows in FIG. 16 A. This circular reference can be mathematically solved as illustrated in FIG. 16B. B_{Y} solving Equation 29 for c_{aY} and substituting c_{aY} into Equations 30 and further substituting Equations 31 into Equations 30, it is possible to convert into an equation of the arrival fluctuation coefficient c_{aZ} alone as expressed Equation 32.

$$[ 1 - \frac{( 1 - {u}_{X}^{2} ) ( 1 - {u}_{Y}^{2} ) ( 1 - {u}_{Z}^{2} )}{4} ] {c}_{aZ}^{2} = {u}_{Y}^{2} \frac{{c}_{mY}^{2} + \sqrt{{k}_{Y} - 1}}{\sqrt{{k}_{Y}}} + ( 1 - {u}_{Y}^{2} ) \{ \frac{1}{2} + \frac{1}{2} {u}_{X}^{2} \frac{{c}_{mX}^{2} + \sqrt{{k}_{X} - 1}}{\sqrt{{k}_{X}}} + \frac{{c}_{a 0}^{2}}{4} ( 1 - {u}_{X}^{2} ) + \frac{( 1 - {u}_{X}^{2} )}{4} {u}_{X}^{2} \frac{{c}_{mX}^{2} + \sqrt{{k}_{Z} - 1}}{\sqrt{{k}_{Z}}} \} \qquad Equation 32$$

Similarly, it is also possible to perform conversion into an equation for the arrival fluctuation coefficient c_{aX} alone and the arrival fluctuation coefficient c_{aY} alone. As a result, the evaluation unit 2031 can obtain the arrival fluctuation coefficients c_{aX} to c_{aZ}.

The evaluation unit 2031 supplies the number of resources k_{X} to k_{Z}, the average arrival rates λ_{X} to λ_{Z}, and the arrival fluctuation coefficients c_{aX} to c_{aZ} to the calculation unit 208.

The calculation unit 208 obtains the average stay times W_{X} to W_{Z} of the process areas S_{X} to S_{Z} from the following Equations 33 using the number of resources k_{X} to k_{Z}, the average operation rates u_{X} to u_{Z}, the average processing times t_{mX} to t_{mZ}, the arrival fluctuation coefficients c_{aX} to c_{aZ}, and the capability fluctuation coefficients c_{mX} to c_{mZ}.

$$\cdot {W}_{i} = \frac{{c}_{ai}^{2} + {c}_{mi}^{2}}{2} \cdot \frac{{u}_{i}^{\sqrt{2 ( {k}_{i} + 1 )} - 1}}{{k}_{i} ( 1 - {u}_{i} )} {t}_{mi} … \{ \begin{matrix}\cdot {W}_{X} = \frac{{c}_{aX}^{2} + {c}_{mX}^{2}}{2} \cdot \frac{{u}_{X}^{\sqrt{2 ( {k}_{X} + 1 )} - 1}}{{k}_{X} ( 1 - {u}_{X} )} {t}_{mX} \\ \cdot {W}_{Y} = \frac{{c}_{aY}^{2} + {c}_{mY}^{2}}{2} \cdot \frac{{u}_{Y}^{\sqrt{2 ( {k}_{Y} + 1 )} - 1}}{{k}_{Y} ( 1 - {u}_{Y} )} {t}_{mY} \\ \cdot {W}_{Z} = \frac{{c}_{aZ}^{2} + {c}_{mZ}^{2}}{2} \cdot \frac{{u}_{Z}^{\sqrt{2 ( {k}_{Z} + 1 )} - 1}}{{k}_{Z} ( 1 - {u}_{Z} )} {t}_{mZ}\end{matrix} \qquad Equation 33$$

The calculation unit 208 obtains the upper limit inventory quantities L_{X} to L_{Z} of inventories B in the process areas S_{X} to S_{Z} from the following Equations 34 using the average arrival rates λ_{X} to λ_{Z} and the average stay times W_{X} to W_{Z}, respectively, expressed Equations 33 on the basis of the Little's law.

$$\cdot {L}_{i} = {λ}_{i} {W}_{i} … \{ \begin{matrix}\cdot {L}_{X} = {λ}_{X} {W}_{X} \\ \cdot {L}_{Y} = {λ}_{Y} {W}_{Y} \\ \cdot {L}_{Z} = {λ}_{Z} {W}_{Z}\end{matrix} \qquad Equation 34$$

The calculation unit 208 sets the appropriate capacities of the inventories B in the process areas S_{X} to S_{Z} to L_{X} to L_{Z} depending on the upper limit inventory quantities L_{X} to L_{Z} expressed in the Equations 34.

The calculation unit 208 stores calculation results 2d including the appropriate capacities L_{X} to L_{Z} of the inventories B of the process areas S_{X} to S_{Z} and the average stay times W_{X} to W_{Z} of the process areas S_{X} to S_{Z} in the storage unit 2.

In addition, the operation of the management system 201 is different from that of the first embodiment in the following points.

In ST2 illustrated in FIG. 7, the evaluation units 2031 and 2032 and the calculation unit 208 obtain the arrival fluctuation characteristics and the capability fluctuation characteristics of the lots in the process areas S in the multiple reenterable process areas S_{X} to S_{Z}.

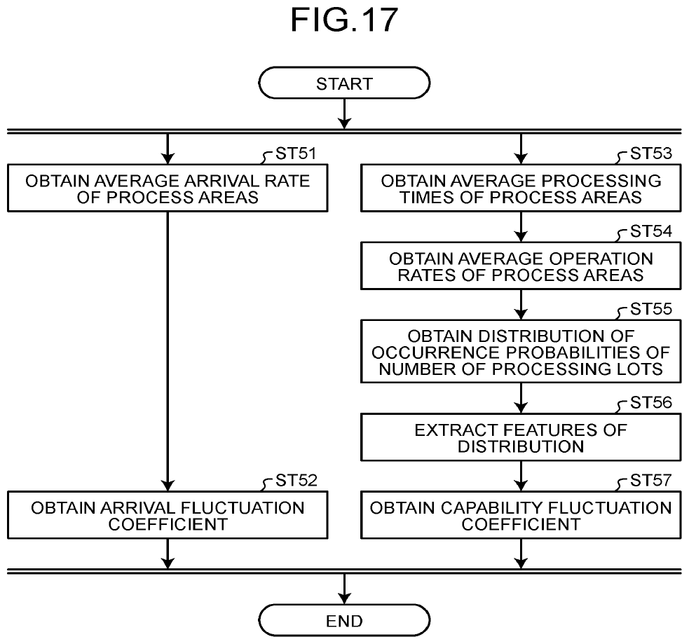

For example, in ST2, ST51 to ST57 illustrated in FIG. 17 may be performed. ST51 to ST52 and ST53 to ST57 may be performed in parallel with each other.

In ST51 to ST52, the evaluation unit 2031 acquires WIP information regarding a predetermined period from the storage unit 2. The evaluation unit 2031 can specify performance of the number of lots in process in each of the process areas S_{X} to S_{Z} on the basis of the WIP information. The evaluation unit 2031 obtains an arrival fluctuation characteristic of lots to the process areas S_{X} to S_{Z} on the basis of performance of the number of lots in process in the process areas S_{X} to S_{Z}, respectively.

In ST51, the evaluation unit 2031 may obtain average arrival time intervals t_{aX} to t_{aZ} of the process areas S_{X} to S_{Z} for the predetermined period as parameters indicating the arrival fluctuation characteristics of lots in the process areas S_{X} to S_{Z}, respectively. The evaluation unit 2031 obtains an arrival time interval of lots to a resource E in each of the process areas S_{X} to S_{Z} for each unit time and obtains an average arrival time interval for multiple resources E. The evaluation unit 2031 time-averages for multiple unit times to obtain the average arrival time intervals t_{aX} to t_{aZ} of the process areas S_{X} to S_{Z}, respectively. The evaluation unit 2031 obtains average arrival rates λ_{X} to λ_{Z} as the reciprocals of the average arrival time intervals t_{aX} to t_{aZ} of the process areas S_{X} to S_{Z}, respectively.

Note that the evaluation unit 2031 may obtain the average arrival rates λ_{X} to λ_{Z} of the process areas S_{X} to S_{Z} by the Equations 26 from the average arrival rate λ₀ of the process area S₀ immediately preceding the multiple reenterable process areas S_{X} to S_{Z}.

The evaluation unit 2031 supplies the average arrival time intervals t_{aX} to t_{aZ} to the evaluation unit 2032.

ST52 will be described later.

In ST53 to ST57, the evaluation unit 2032 acquires throughput information for a predetermined period from the storage unit 2. The evaluation unit 2032 can specify the performance of the number of processing lots in each of the process areas S_{X} to S_{Z} on the basis of the throughput information. The evaluation unit 2032 obtains a capability fluctuation characteristic of each resource E in the process areas S_{X} to S_{Z} on the basis of the performance of the number of processing lots in the process area S_{X} to S_{Z}, respectively.

In ST53, the evaluation unit 2032 may further obtain the average processing times t_{mX} to t_{mZ} of the process areas S_{X} to S_{Z} for the predetermined period as parameters indicating the capability fluctuation characteristics of the process areas S_{X} to S_{Z}, respectively. The evaluation unit 2032 obtains a processing time of a lot by each resource E for each unit time and obtains an average processing time for multiple resources E in each of the process areas S_{X} to S_{Z}. The evaluation unit 2032 time-averages for multiple unit times to obtain the average processing times t_{mX} to t_{mZ} of the process areas S_{X} to S_{Z}, respectively.

In ST54, the evaluation unit 2032 acquires the number-of-resources information from the storage unit 2 and specifies the number of resources k_{X} to k_{Z} of the process areas S_{X} to S_{Z}, respectively, according to the number-of-resources information. The evaluation unit 2032 acquires the average arrival time intervals t_{aX} to t_{aZ} from the evaluation unit 1031. The evaluation unit 2032 may obtain average operation rates u_{X} to u_{Z} of the process areas S_{X} to S_{Z} from Equations 27 using the average processing times t_{mX} to t_{mZ}, the average arrival time intervals t_{aX} to t_{aZ}, and the number of resources k_{X} to k_{Z}.

In ST55, the evaluation unit 2032 obtains a distribution of occurrence probabilities of the number of processing lots. For example, the evaluation unit 2032 analyzes the number of processing lots of each resource E as output for each of the process areas S_{X} to S_{Z} for each unit time and obtains the total number of processing lots for the multiple resources E. The evaluation unit 2032 performs statistical processing on multiple unit times to obtain a distribution of the total number of processing lots.

In ST56, the evaluation unit 2032 can extract features (for example, average values m_{mX} to m_{mZ} and the variances σ_{mX}² to σ_{mz}²) of the distributions obtained in ST55 for the process areas S_{X} to S_{Z} and use the features as parameters indicating the capability fluctuation characteristics of the process areas S_{X} to S_{Z}, respectively.

In ST57, the evaluation unit 2032 can obtain the capability fluctuation coefficients c_{mX} to c_{mZ} as expressed Equations 28 as coefficients representing fluctuations in the number of processing lots in the process areas S_{X} to S_{Z}, respectively.

The evaluation unit 2032 supplies the average operation rates u_{X} to u_{Z}, the average processing times t_{mX} to t_{mZ}, and the capability fluctuation coefficients c_{mX} to c_{mZ} to each of the evaluation unit 2031 and the calculation unit 208.

In ST52, the evaluation unit 2031 acquires the number-of-resources information from the storage unit 2 and specifies the number of resources k_{X} to k_{Z} of the process areas S_{X} to S_{Z}, respectively, according to the number-of-resources information. The evaluation unit 2031 acquires the average operation rates u_{X} to u_{Z} and the capability fluctuation coefficients c_{mX} to c_{mZ} from the evaluation unit 2032. The evaluation unit 2031 may use the number of resources k_{X} to k_{Z}, the average arrival rates λ_{X} to λ_{Z}, the average operation rates u_{X} to u_{Z}, and the capability fluctuation coefficients c_{mX} to c_{mZ} to obtain the arrival fluctuation coefficients c_{aX} to c_{aZ} as expressed in the Equations 29 to 31.

The evaluation unit 2031 supplies the number of resources k_{X} to k_{Z}, the average arrival rates λ_{X} to λ_{Z}, and the arrival fluctuation coefficients c_{aX} to c_{aZ} to the calculation unit 208.

In ST3 illustrated in FIG. 7, the calculation unit 208 obtains inventory information on the basis of the arrival fluctuation characteristic and the capability fluctuation characteristic obtained in ST2.

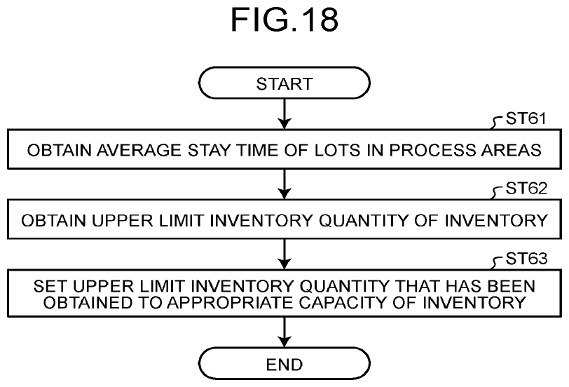

For example, in ST3, ST61 to ST63 illustrated in FIG. 18 may be performed.

In ST61, the calculation unit 208 obtains the average stay times W_{X} to W_{Z} of the process areas S_{X} to S_{Z} from Equations 33 using the number of resources k_{X} to k_{Z}, the average operation rates u_{X} to u_{Z}, the average processing times t_{mX} to t_{mZ}, the arrival fluctuation coefficients c_{aX} to c_{aZ}, and the capability fluctuation coefficients c_{mX} to c_{mZ}.

In ST62, the calculation unit 208 obtains the upper limit inventory quantities L_{X} to L_{Z} of inventories B in the process areas S_{X} to S_{Z} from Equations 34 using the average arrival rates λ_{X} to λ_{Z} and the average stay times W_{X} to W_{Z}, respectively, expressed Equations 33.

In ST63, the appropriate capacities of the inventories B in the process areas S_{X} to S_{Z} are set to L_{X} to L_{Z}.

The calculation unit 108 stores the calculation results 2d including the appropriate capacities L_{X} to L_{Z} of the inventories B of the process areas S_{X} to S_{Z} and the average stay times W_{X} to W_{Z} of the process areas S_{X} to S_{Z} in the storage unit 2.

As described above, in the third embodiment, in the management method for the manufacturing line P, the upper limit inventory quantities L_{X} to L_{Z} of the inventories B are obtained depending on the arrival fluctuation characteristics of the lots to the reenterable process areas S_{X} to S_{Z} and the capability fluctuation characteristics of the reenterable process areas S_{X} to S_{Z}, and the appropriate capacities of the inventories B are set to L_{X} to L_{Z}. As a result, an upper limit inventory quantity L_{q} of an inventory B is obtained in consideration of the fluctuation in the inventory quantity corresponding to the fluctuation in the arrival of lots and the fluctuation in the processing capacity for each reenterable process area S, and the upper limit inventory quantity L_{q} can be notified to the user.

In addition, in the third embodiment, in the management method for the manufacturing line P, the average stay times W_{X} to W_{Z} of the process areas S_{X} to S_{Z} are obtained depending on the arrival fluctuation characteristics of the lots to the reenterable process areas S_{X} to S_{Z} and the capability fluctuation characteristics of the reenterable process areas S_{X} to S_{Z}. As a result, for each reenterable process area S, an average stay time W of each process area S is obtained in consideration of the fluctuation in the inventory quantity corresponding to the fluctuation in the arrival of lots and the fluctuation in the processing capacity, and the average stay time W can be notified to the user.

### Fourth Embodiment

Next, a management method for a manufacturing line according to a fourth embodiment will be described. Hereinafter, differences from the first to third embodiments will be mainly described.

In the first embodiment, the management of the manufacturing line P focusing on the flow of lots for each process area S has been illustrated as an example; however, in the fourth embodiment, management of a manufacturing line P focusing on the flow of lots in two adjacent process areas S that are bottlenecks is illustrated as an example.

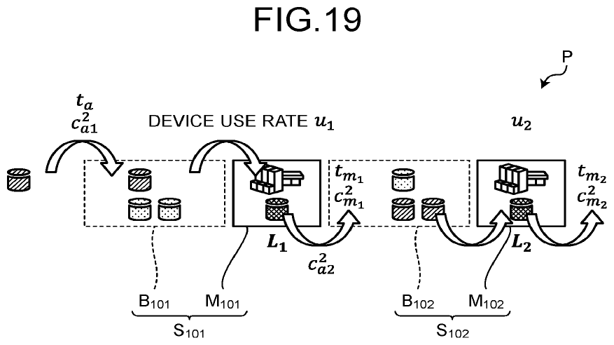

For example, as illustrated in FIG. 19, a case where the manufacturing line P includes two adjacent process areas S₁₀₁ and S₁₀₂ that are bottlenecks will be examined. FIG. 19 is a diagram illustrating a configuration of the manufacturing line P in the fourth embodiment.

The two adjacent process areas S₁₀₁ and S₁₀₂ sequentially process lots. The process area S₁₀₁ is also referred to as a preceding process area S₁₀₁, and the process area S₁₀₂ is also referred to as a subsequent process area S₁₀₂.

Each of the process areas S₁₀₁ and S₁₀₂ has an inventory B and a resource group M. The process area S₁₀₁ includes an inventory B₁₀₁ and a resource group M₁₀₁. The resource group M₁₀₁ includes multiple resources E. The process area S₁₀₂ includes an inventory B₁₀₂ and a resource group M₁₀₂. The resource group M₁₀₂ includes multiple resources E.

In a case where the capabilities of the two adjacent process areas S₁₀₁ and S₁₀₂ are equivalent, it may be difficult for a lot to flow between the two adjacent process areas S₁₀₁ and S₁₀₂. In order for a lot to smoothly flow between the two adjacent process areas S₁₀₁ and S₁₀₂, it is desirable to suppress exhaustion of the inventory B₁₀₂ in the subsequent process area S₁₀₂.

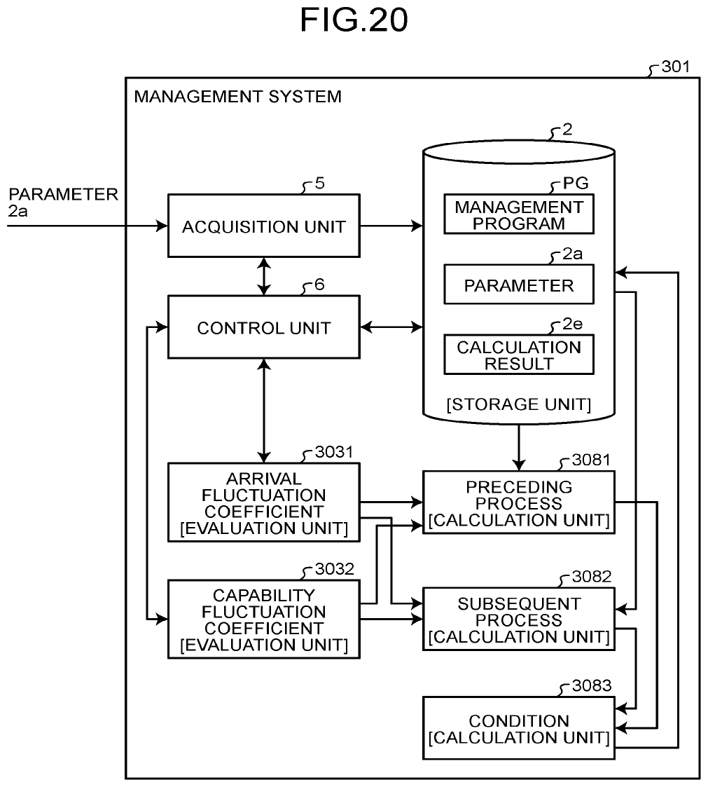

Each manufacturing line P as illustrated in FIG. 19 can be managed by a management system 301 as illustrated in FIG. 20. FIG. 20 is a diagram illustrating a functional configuration of the management system 301.

The management system 301 includes an evaluation unit 3031, an evaluation unit 3032, a calculation unit 3081, a calculation unit 3082, and a calculation unit 3083 instead of the evaluation unit 3 and the calculation unit 8 (see FIG. 4).

The evaluation unit 3031 obtains parameters indicating arrival fluctuation characteristics of lots to the two adjacent process areas S₁₀₁ and S₁₀₂ and supplies the parameters to the calculation units 3081 and 3082. The evaluation unit 3032 obtains parameters indicating capability fluctuation characteristics of the two adjacent process areas S₁₀₁ and S₁₀₂ and supplies the parameters to the calculation units 3081 and 3082. The calculation unit 3081 obtains inventory information by using a parameter indicating an arrival fluctuation characteristic of the preceding process area S₁₀₁ and a parameter indicating a capability fluctuation characteristic of the preceding process area S₁₀₁. The calculation unit 3081 may obtain an average inventory quantity L₁ of the inventory B₁₀₁ in the preceding process area S₁₀₁ as the inventory information. The calculation unit 3082 obtains inventory information by using a parameter indicating an arrival fluctuation characteristic of the subsequent process area S₁₀₂ and a parameter indicating a capability fluctuation characteristic of the subsequent process area S₁₀₂. The calculation unit 3082 may obtain an average inventory quantity L₂ of the inventory B₁₀₂ in the subsequent process area S₁₀₂ as the inventory information. The calculation unit 3083 derives a condition under which the average inventory quantity L₂ of the inventory B₁₀₂ in the subsequent process area S₁₀₂ is larger than the average inventory quantity L₁ of the inventory B₁₀₁ in the preceding process area S₁₀₁.

For example, the evaluation unit 3031 acquires WIP information regarding a predetermined period from a storage unit 2. The evaluation unit 3031 can specify performances of the number of lots in process in each of the process areas S₁₀₁ and S₁₀₂ on the basis of the WIP information. The evaluation unit 3031 obtains arrival fluctuation characteristics of lots to the process areas S₁₀₁ and S₁₀₂ on the basis of the performance of the number of lots in process in the process areas S₁₀₁ and S₁₀₂.

The evaluation unit 3031 analyzes the number of lots in process of each resource E in the preceding process area S₁₀₁ as input for each unit time and obtains the total number of lots in process for multiple resources E. The evaluation unit 3031 performs statistical processing on multiple unit times to obtain a distribution of the total number of lots in process. The evaluation unit 3031 can extract features of the distribution (for example, the average value mₐ₁ and the variance σₐ₁²) and use the features as parameters indicating the arrival fluctuation characteristics of lots to the inventory sharing unit U.

The evaluation unit 3031 can obtain an arrival fluctuation coefficient cₐ₁ as expressed in the following Equation 35 as a coefficient representing the fluctuation in the number of lots in process in the preceding process area S₁₀₁.

$${c}_{a 1} = {σ}_{a 1} / {m}_{a 1} \qquad Equation 35$$

Similarly, the evaluation unit 3031 can obtain an arrival fluctuation coefficient cₐ₂ as expressed in the following Equation 36 as a coefficient representing the fluctuation in the number of lots in process in the subsequent process area S₁₀₂.

$${c}_{a 2} = {σ}_{a 2} / {m}_{a 2} \qquad Equation 36$$

Incidentally, in a case where the capabilities of the two adjacent process areas S₁₀₁ and S₁₀₂ are equivalent to each other, the arrival fluctuation coefficients cₐ₁ and cₐ₂ are approximately equal to each other and thus are denoted as cₐ as expressed in the following Equation 37.

$${c}_{a 1} \approx {c}_{a 2} ≡ {c}_{a} \qquad Equation 37$$

The evaluation unit 3031 may obtain the average arrival time interval tₐ₁ of the preceding process area S₁₀₁ for a predetermined period as a parameter indicating an arrival fluctuation characteristic of lots to the preceding process area S₁₀₁. The evaluation unit 3031 obtains an arrival time interval of lots to the resources E in the preceding process area S₁₀₁ for each unit time and obtains an average arrival time interval for the multiple resources E. The evaluation unit 3031 time-averages for multiple unit times to obtain an average arrival time interval tₐ₁ of the preceding process area S₁₀₁.

Similarly, the evaluation unit 3031 obtains an average arrival time interval tₐ₂ of the subsequent process area S₁₀₂.

Incidentally, in a case where the capabilities of the two adjacent process areas S₁₀₁ and S₁₀₂ are equivalent to each other, the average arrival time intervals tai and tₐ₂ are approximately equal to each other and thus are denoted as tₐ as expressed in the following Equation 38.

$${T}_{a 1} \approx {t}_{a 2} ≡ {t}_{a} \qquad Equation 38$$

The evaluation unit 3031 supplies the arrival fluctuation coefficient cₐ and the average arrival time interval tₐ to each of the calculation units 3081 and 3082.

The evaluation unit 3032 acquires throughput information for a period T from the storage unit 2. The evaluation unit 3032 can specify the performance of the number of processing lots in the two adjacent process areas S₁₀₁ and S₁₀₂ on the basis of the throughput information. The evaluation unit 3032 obtains the capability fluctuation characteristics of the resources E in the two adjacent process areas S₁₀₁ and S₁₀₂ on the basis of the performance of the number of processing lots in the two adjacent process areas S₁₀₁ and S₁₀₂.

The evaluation unit 3032 analyzes the number of processing lots of each resource E in the preceding process area S₁₀₁ as output for each unit time and obtains the total number of processing lots for the multiple resources E. The evaluation unit 3032 performs statistical processing on multiple unit times to obtain a distribution of the total number of processing lots. The evaluation unit 3032 can extract features of the distribution (for example, an average value mₘ₁ and a variance σₘ₁²) and set the features as parameters indicating the capability fluctuation characteristic of the preceding process area S₁₀₁.

The evaluation unit 3032 can obtain a capability fluctuation coefficient cₘ₁ as expressed in the following Equation 39 as a coefficient representing the fluctuation in the number of processing lots in the preceding process area S₁₀₁.

$${c}_{m 1} = {σ}_{m 1} / {m}_{m 1} \qquad Equation 39$$

Similarly, the evaluation unit 3032 can obtain a capability fluctuation coefficient cₘ₂ as expressed in the following Equation 40 as a coefficient representing the fluctuation in the number of processing lots in the subsequent process area S₁₀₂.

$${c}_{m 2} = {σ}_{m 2} / {m}_{m 2} \qquad Equation 40$$

Incidentally, in a case where the capabilities of the two adjacent process areas S₁₀₁ and S₁₀₂ are equivalent to each other, the capability fluctuation coefficients cₘ₁ and cₘ₂ are approximately equal to each other and thus are denoted as cₘ as expressed in the following Equation 41.

$${c}_{m 1} \approx {c}_{m 2} ≡ {c}_{m} \qquad Equation 41$$

The evaluation unit 3032 may further obtain an average processing time tₘ₁ of the preceding process area S₁₀₁ for the period T as a parameter indicating the capability fluctuation characteristic of the preceding process area S₁₀₁. The evaluation unit 3032 obtains a processing time of a lot by each resource E for each unit time and obtains an average processing time for the multiple resources E in the preceding process area S₁₀₁. The evaluation unit 3032 time-averages for multiple unit times to obtain an average processing time tₘ₁ of the preceding process area S₁₀₁.

Similarly, the evaluation unit 3032 obtains the average processing time tₘ₂ of the subsequent process area S₁₀₂.

Incidentally, in a case where the capabilities of the two adjacent process areas S₁₀₁ and S₁₀₂ are equivalent to each other, the average processing times tₘ₁ and tₘ₂ are approximately equal to each other and thus are denoted as tₘ as expressed in the following Equation 42.

$${t}_{m 1} \approx {t}_{m 2} ≡ {t}_{m} \qquad Equation 42$$

The evaluation unit 3032 supplies the capability fluctuation coefficient cₘ and the average processing time tₘ to each of the calculation units 3081 and 3082.

The calculation unit 3081 obtains the average inventory quantity L₁ of the preceding process area S₁₀₁ from the following Equation 43 by using the arrival fluctuation coefficient cₐ, the average arrival time interval tₐ, the capability fluctuation coefficient cₘ, and the average processing time tₘ. The average inventory quantity L₁ is the inventory quantity of the inventory B₁₀₁ per unit time.

$${L}_{1} = \frac{{c}_{a}^{2} + {c}_{m}^{2}}{2 {t}_{a}} \frac{{t}_{m}^{2}}{{t}_{a} - {t}_{m}} \qquad Equation 43$$

The calculation unit 3081 supplies the average inventory quantity L₁ of the preceding process area S₁₀₁ to the calculation unit 3083.

The calculation unit 3082 obtains the average inventory quantity L₂ of the preceding process area S₁₀₂ from the following Equation 44 by using the arrival fluctuation coefficient cₐ, the average arrival time interval tₐ, the capability fluctuation coefficient cₘ, and the average processing time tₘ. The average inventory quantity L₂ is the inventory quantity of the inventory B₁₀₂ per unit time.

$${L}_{2} = \frac{( {t}_{a}^{2} - {t}_{m}^{2} ) {c}_{a}^{2} + ( {t}_{a}^{2} - {t}_{m}^{2} ) {c}_{m}^{2}}{2 {t}_{a}^{3}} \frac{{t}_{m}^{2}}{{t}_{a} - {t}_{m}} \qquad Equation 44$$

The calculation unit 3082 supplies the average inventory quantity L₂ of the subsequent process area S₁₀₂ to the calculation unit 3083.

As mentioned before, in order for a lot to smoothly flow between the two adjacent process areas S₁₀₁ and S₁₀₂, it is desirable to suppress exhaustion of the inventory B₁₀₂ in the subsequent process area S₁₀₂.

The calculation unit 3083 calculates a condition under which the average inventory quantity L₂ of the subsequent process area S₁₀₂ is larger than the average inventory quantity L₁ of the preceding process area S₁₀₁ depending on the average inventory quantity L₁ of the preceding process area S₁₀₁ and the average inventory quantity L₂ of the subsequent process area S₁₀₂.

The calculation unit 3083 may calculate how the magnitude relationship between the average inventory quantity L₁ and the average inventory quantity L₂ changes while changing the magnitude relationship between the arrival fluctuation coefficient cₐ and the capability fluctuation coefficient cₘ.

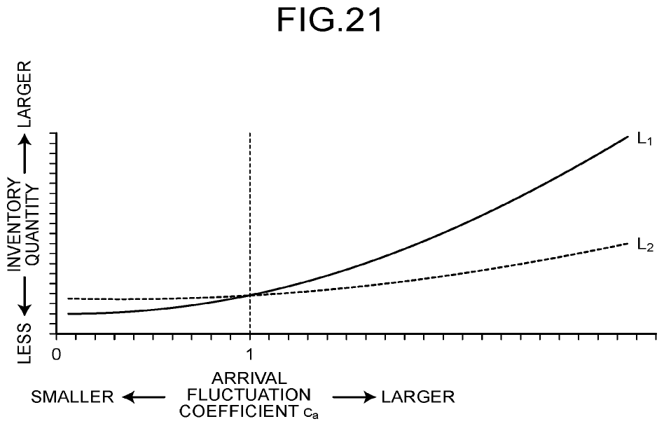

For example, in a case where tₘ=10, tₐ=12, and cₘ=1 are substituted into each of the average inventory quantity L₁ expressed Equation 43 and the average inventory quantity L₂ expressed Equation 44, and ca is changed before and after 1, the average inventory quantity L₁ and the average inventory quantity L₂ change as illustrated in FIG. 21. FIG. 21 is a graph illustrating inventory fluctuations in the two adjacent process areas S₁₀₁ and S102. In FIG. 21, the vertical axis represents the average inventory quantity, and the horizontal axis represents the magnitude of the arrival fluctuation coefficient ca. Since the capability fluctuation coefficient is fixed at cₘ=1, the range of the arrival fluctuation coefficient ca<1 on the horizontal axis corresponds to the magnitude relationship of “arrival fluctuation coefficient ca”<“capability fluctuation coefficient cₘ”. The range of the arrival fluctuation coefficient ca>1 on the horizontal axis corresponds to the magnitude relationship of “arrival fluctuation coefficient ca”>“capability fluctuation coefficient cₘ”.

As illustrated in FIG. 21, when the arrival fluctuation coefficient cₐ of each of the areas S₁₀₁ and S₁₀₂ becomes larger than 1, the average inventory quantity L₁ of the preceding process area S₁₀₁ becomes dramatically larger than the average inventory quantity L₂ of the subsequent process area S₁₀₂. As a result, it can be seen that lots are likely to be excessively accumulated in the inventory B₁₀₁ in the preceding process area S₁₀₁ and that lots are likely to be exhausted in the inventory B₁₀₂ in the subsequent process area S₁₀₂ when the arrival fluctuation coefficient cₐ is relatively larger than the capability fluctuation coefficient cₘ.

On the other hand, when the arrival fluctuation coefficient cₐ of each of the areas S₁₀₁ and S₁₀₂ becomes smaller than 1, the average inventory quantity L₁ of the preceding process area S₁₀₁ becomes smaller than the average inventory quantity L₂ of the subsequent process area S₁₀₂; however, a difference between the two is small.

Accordingly, it can be seen that, in a case where the arrival fluctuation coefficient cₐ is relatively smaller than the capability fluctuation coefficient cₘ, lots easily flow smoothly between the two adjacent process areas S₁₀₁ and S₁₀₂ and that exhaustion of the inventory B₁₀₂ in the subsequent process area S₁₀₂ can be suppressed.

According to this calculation result, the calculation unit 3083 obtains a condition represented by the following Equation 45 as a condition under which the average inventory quantity L₂ of the subsequent process area S₁₀₂ is larger than the average inventory quantity L₁ of the preceding process area S₁₀₁.

$${c}_{a} < {c}_{m} \qquad Equation 45$$

The condition expressed by Equation 45 is expressed by the following Equations 46 when expressed for the two adjacent process areas S₁₀₁ and S₁₀₂.

$${c}_{a 1} < {c}_{m 1} , {c}_{a 2} < {c}_{m 2} \qquad Equation 46$$

The calculation unit 3083 may obtain the conditions expressed in Equations 46 instead of the condition expressed in Equation 45.

The calculation unit 3083 stores, in the storage unit 2, calculation results 2e including the average inventory quantity L₁ of the preceding process area S₁₀₁, the average inventory quantity L₂ of the subsequent process area S₁₀₂, and the condition(s) expressed in Equation 45 or Equations 46.

In addition, the operation of the management system 301 is different from that of the first embodiment in the following points.

In ST2 illustrated in FIG. 7, the evaluation units 3031 and 3032 obtain the arrival fluctuation characteristics and the capability fluctuation characteristics of the two adjacent process areas S₁₀₁ and S₁₀₂.

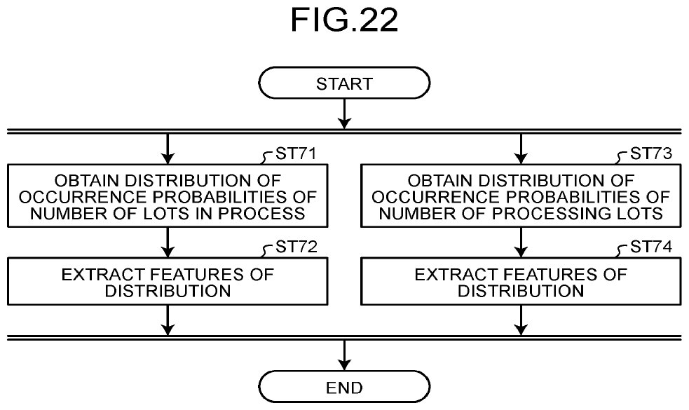

For example, in ST2, ST71 to ST74 illustrated in FIG. 22 may be performed. ST71 to ST72 and ST73 to ST74 may be performed in parallel with each other.

In ST71 to ST72, the evaluation unit 3031 acquires WIP information regarding a predetermined period from the storage unit 2. The evaluation unit 3031 can specify performances of the number of lots in process in each of the process areas S₁₀₁ and S₁₀₂ on the basis of the WIP information. The evaluation unit 3031 obtains arrival fluctuation characteristics of lots to the process areas S₁₀₁ and S₁₀₂ on the basis of the performance of the number of lots in process in the process areas S₁₀₁ and S₁₀₂.

In ST71, the evaluation unit 3031 obtains a distribution of occurrence probabilities of the number of lots in process. For example, the evaluation unit 3031 analyzes the number of lots in process of each resource E in the preceding process area S₁₀₁ as input for each unit time and obtains the total number of lots in process for the multiple resources E. The evaluation unit 3031 performs statistical processing on multiple unit times to obtain a distribution of the total number of lots in process.

In ST72, the evaluation unit 3031 can extract features of the distribution (for example, the average value mₐ₁ and the variance σₐ₁²) obtained in ST71 and use the features as parameters indicating the arrival fluctuation characteristic of lots to the inventory sharing unit U.

The evaluation unit 3031 can obtain the arrival fluctuation coefficient cₐ₁ as expressed Equation 35 as the coefficient representing the fluctuation in the number of lots in process in the preceding process area S₁₀₁.

Similarly, the evaluation unit 3031 can obtain the arrival fluctuation coefficient cₐ₂ as expressed Equation 36 as a coefficient representing the fluctuation in the number of lots in process in the subsequent process area S₁₀₂.

Incidentally, in a case where the capabilities of the two adjacent process areas S₁₀₁ and S₁₀₂ are equivalent to each other, the arrival fluctuation coefficients cₐ₁ and cₐ₂ are approximately equal to each other and thus are denoted as cₐ as expressed in Equation 37.

The evaluation unit 3031 may obtain the average arrival time interval tₐ₁ of the preceding process area S₁₀₁ for a predetermined period as a parameter indicating an arrival fluctuation characteristic of lots to the preceding process area S₁₀₁. The evaluation unit 3031 obtains an arrival time interval of lots to the resources E in the preceding process area S₁₀₁ for each unit time and obtains an average arrival time interval for the multiple resources E. The evaluation unit 3031 time-averages for multiple unit times to obtain an average arrival time interval tₐ₁ of the preceding process area S₁₀₁.

Similarly, the evaluation unit 3031 obtains an average arrival time interval tₐ₂ of the subsequent process area S₁₀₂.

The evaluation unit 3031 supplies the arrival fluctuation coefficient cₐ and the average arrival time interval tₐ to each of the calculation units 3081 and 3082.

In ST73 to ST74, the evaluation unit 3032 acquires the throughput information for the period T from the storage unit 2. The evaluation unit 3032 can specify the performance of the number of processing lots in the two adjacent process areas S₁₀₁ and S₁₀₂ on the basis of the throughput information. The evaluation unit 1032 obtains the capability fluctuation characteristics of the resources E in the two adjacent process areas S₁₀₁ and S₁₀₂ on the basis of the performance of the number of processing lots in the two adjacent process areas S₁₀₁ and S₁₀₂.

In ST73, the evaluation unit 3032 obtains the distribution of occurrence probabilities of the number of processing lots. For example, the evaluation unit 3032 analyzes the number of processing lots of each resource E in the preceding process area S₁₀₁ as output for each unit time and obtains the total number of processing lots for the multiple resources E. The evaluation unit 3032 performs statistical processing on multiple unit times to obtain a distribution of the total number of processing lots.

In ST74, the evaluation unit 3032 can extract features (for example, the average value mₘ₁ and the variance σₘ₁²) of the distribution obtained in ST73 and use the features as parameters indicating the capability fluctuation characteristic of the preceding process area S₁₀₁.

The evaluation unit 3032 can obtain the capability fluctuation coefficient cmi as expressed Equation 39 as the coefficient representing the fluctuation in the number of processing lots in the preceding process area S₁₀₁.

Similarly, the evaluation unit 3032 can obtain the capability fluctuation coefficient cₘ₂ as expressed Equation 40 as the coefficient representing the fluctuation in the number of processing lots in the subsequent process area S₁₀₂.

Incidentally, in a case where the capabilities of the two adjacent process areas S₁₀₁ and S₁₀₂ are equivalent to each other, the capability fluctuation coefficients cₘ₁ and cₘ₂ are approximately equal to each other and thus are denoted as cₘ as expressed in Equation 41.

The evaluation unit 3032 may further obtain an average processing time tₘ₁ of the preceding process area S₁₀₁ for the period T as a parameter indicating the capability fluctuation characteristic of the preceding process area S₁₀₁. The evaluation unit 3032 obtains a processing time of a lot by each resource E for each unit time and obtains an average processing time for the multiple resources E in the preceding process area S₁₀₁. The evaluation unit 3032 time-averages for multiple unit times to obtain an average processing time tₘ₁ of the preceding process area S₁₀₁.

Similarly, the evaluation unit 3032 obtains the average processing time tₘ₂ of the subsequent process area S₁₀₂.

Incidentally, in a case where the capabilities of the two adjacent process areas S₁₀₁ and S₁₀₂ are equivalent to each other, the average processing times tₘ₁ and tₘ₂ are approximately equal to each other and thus are denoted as tₘ as expressed in Equation 42.

The evaluation unit 3032 supplies the capability fluctuation coefficient cₘ and the average processing time tₘ to each of the calculation units 3081 and 3082.

In ST3 illustrated in FIG. 7, the calculation units 3081, 3082, and 3083 obtain inventory information of the two adjacent process areas S₁₀₁ and S₁₀₂.

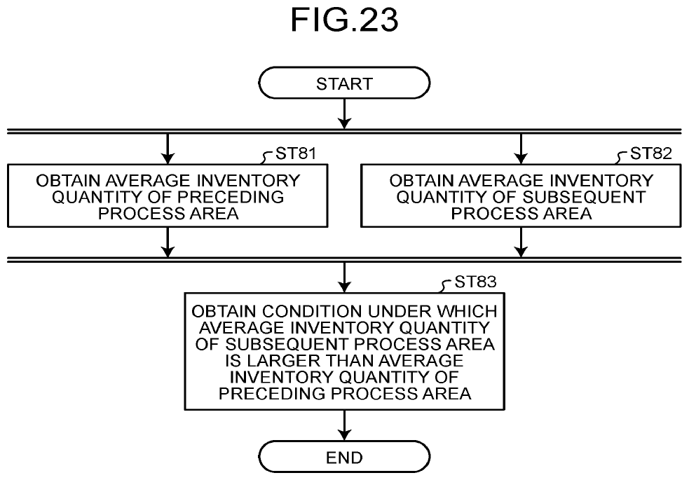

For example, in ST3, ST81 to ST83 illustrated in FIG. 23 may be performed. ST81 and ST82 may be performed in parallel with each other.

In ST81, the calculation unit 3081 obtains the average inventory quantity L₁ of the preceding process area S₁₀₁ from Equation 43 by using the arrival fluctuation coefficient cₐ, the average arrival time interval tₐ, the capability fluctuation coefficient cₘ, and the average processing time tₘ. The average inventory quantity L₁ is the inventory quantity of the inventory B₁₀₁ per unit time.

The calculation unit 3081 supplies the average inventory quantity L₁ of the preceding process area S₁₀₁ to the calculation unit 3083.

In ST82, the calculation unit 3082 obtains the average inventory quantity L₂ of the subsequent process area S₁₀₂ from Equation 44 by using the arrival fluctuation coefficient cₐ, the average arrival time interval tₐ, the capability fluctuation coefficient cₘ, and the average processing time tₘ. The average inventory quantity L₂ is the inventory quantity of the inventory B₁₀₂ per unit time.

The calculation unit 3082 supplies the average inventory quantity L₂ of the subsequent process area S₁₀₂ to the calculation unit 3083.

In ST83, the calculation unit 3083 calculates a condition under which the average inventory quantity L₂ of the subsequent process area S₁₀₂ is larger than the average inventory quantity L₁ of the preceding process area S₁₀₁ depending on the average inventory quantity L₁ of the preceding process area S₁₀₁ and the average inventory quantity L₂ of the subsequent process area S₁₀₂.

The calculation unit 3083 may calculate how the magnitude relationship between the average inventory quantity L₁ and the average inventory quantity L₂ changes while changing the magnitude relationship between the arrival fluctuation coefficient cₐ and the capability fluctuation coefficient cₘ.

According to the calculation result, the calculation unit 3083 obtains the condition represented by Equation 45 as the condition under which the average inventory quantity L₂ of the subsequent process area S₁₀₂ is larger than the average inventory quantity L₁ of the preceding process area S₁₀₁.

The calculation unit 3083 may obtain the conditions expressed in Equations 46 instead of the condition expressed in Equation 45.

The calculation unit 3083 stores, in the storage unit 2, calculation results 2e including the average inventory quantity L₁ of the preceding process area S₁₀₁, the average inventory quantity L₂ of the subsequent process area S₁₀₂, and the condition(s) expressed in Equation 45 or Equations 46.

As described above, in the fourth embodiment, in the management method for the manufacturing line P, the inventory information is obtained on the basis of the arrival fluctuation characteristics of lots to the two adjacent process areas S₁₀₁ and S₁₀₂ and the capability fluctuation characteristics of the two adjacent process areas S₁₀₁ and S₁₀₂. For example, the average inventory quantity L₁ of the inventory B₁₀₁ in the preceding process area S₁₀₁ and the average inventory quantity L₂ of the inventory B₁₀₂ in the subsequent process area S₁₀₂ are obtained using the parameter indicating the arrival fluctuation characteristic of the preceding process area S₁₀₁, the parameter indicating the arrival fluctuation characteristic of the subsequent process area S₁₀₂, respectively, and the parameter indicating the capability fluctuation characteristic of the preceding process area S₁₀₁ and the parameter indicating the capability fluctuation characteristic of the subsequent process area S₁₀₂, respectively. As a result, the average inventory quantities L₁ and L₂ of the inventories B₁₀₁ and B₁₀₂ in the two adjacent process areas S₁₀₁ and S₁₀₂ are obtained in consideration of the fluctuation in the arrival of lots to the two adjacent process areas S₁₀₁ and S₁₀₂ and the fluctuation in the inventory quantity corresponding to the fluctuation in the processing capacity of the two adjacent process areas S₁₀₁ and S₁₀₂, and the average inventory quantities L₁ and L₂ can be notified to the user.

Furthermore, in the fourth embodiment, in the management method for the manufacturing line P, it is possible to obtain a condition under which the average inventory quantity L₂ of the inventory B₁₀₂ in the subsequent process area S₁₀₂ is larger than the average inventory quantity L₁ of the inventory B₁₀₁ in the preceding process area S₁₀₁ in the two adjacent process areas S₁₀₁ and S₁₀₂. As a result, it is possible to prompt the user to perform improvement for enabling lots to smoothly flow between the two adjacent process areas S₁₀₁ and S₁₀₂. As a result, the lots can be efficiently processed in the manufacturing line P.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A management method for a manufacturing line, the management method comprising:
obtaining a fluctuation characteristic including at least one of an arrival fluctuation characteristic of a lot to a process area, a capability fluctuation characteristic of the process area, or a stay fluctuation characteristic of the lot in the process area in a manufacturing line in which multiple process areas including the process area are arranged, the multiple process areas each including multiple resources; and
obtaining inventory information regarding an inventory to be provided in the process area depending on the fluctuation characteristic.

2. The management method for a manufacturing line according to claim 1,
wherein the obtaining the fluctuation characteristic includes:
obtaining the stay fluctuation characteristic of the lot in the process area on a basis of the arrival fluctuation characteristic of the lot to the process area and the capability fluctuation characteristic of the process area.

3. The management method for a manufacturing line according to claim 2,
wherein the obtaining the inventory information includes:
obtaining an appropriate capacity of the inventory that enables the resources of the process area to continuously operate depending on the stay fluctuation characteristic.

4. The management method for a manufacturing line according to claim 2,
wherein the obtaining the inventory information includes:
obtaining an appropriate capacity of the inventory with which an operation loss of resources of the process area becomes zero depending on the stay fluctuation characteristic.

5. The management method for a manufacturing line according to claim 2,
wherein the obtaining an appropriate capacity of the inventory includes:
obtaining an average processing time of resources in the process area on a basis of the capability fluctuation characteristic;
obtaining an occurrence probability of an operation loss of the resources of the process area on a basis of the stay fluctuation characteristic; and
determining an appropriate capacity of the inventory depending on the average processing time and the occurrence probability.

6. The management method for a manufacturing line according to claim 5,
wherein the determining the appropriate capacity of the inventory includes:
obtaining a number of lots with which an operation rate of the resources in the process area becomes zero by using the average processing time and the occurrence probability; and
setting the appropriate capacity of the inventory to greater than or equal to the number of lots that has been obtained.

7. The management method for a manufacturing line according to claim 5,
wherein the obtaining the fluctuation characteristic includes:
obtaining a distribution of occurrence probabilities of a number of staying lots;
extrapolating the distribution to a side where the number of staying lots is negative; and
extracting a feature of the distribution that has been extrapolated, and
the obtaining the occurrence probability of the operation loss includes:
integrating a portion where the number of staying lots in the distribution that has been extrapolated is negative.

8. The management method for a manufacturing line according to claim 7,
wherein the extracting the feature includes:
obtaining a fluctuation coefficient of the distribution, and
the integrating includes:
integrating a portion where the number of staying lots is negative in the distribution that has been extrapolated using the fluctuation coefficient.

9. The management method for a manufacturing line according to claim 1,
wherein an inventory sharing unit is included in the multiple process areas, the inventory sharing unit including two or more process areas sharing an inventory,
the obtaining the fluctuation characteristic includes:
obtaining a stay fluctuation characteristic of a lot in the inventory sharing unit on a basis of an arrival fluctuation characteristic of the lot to the inventory sharing unit and a capability fluctuation characteristic of the inventory sharing unit, and
the obtaining the inventory information includes:
obtaining an upper limit inventory quantity of the inventory of the inventory sharing unit depending on the stay fluctuation characteristic of the lot in the inventory sharing unit.

10. The management method for a manufacturing line according to claim 9,
wherein, in the multiple process areas, a signboard associated with a lot input to the inventory sharing unit from a process area immediately preceding the inventory sharing unit can be put in place in the inventory, and
the obtaining the inventory information further includes:
setting the upper limit inventory quantity that has been obtained as an appropriate number of the signboards.

11. The management method for a manufacturing line according to claim 9,
wherein the obtaining the inventory information further includes:
obtaining an average stay time of the inventory sharing unit depending on an average number of lots to stay in the inventory sharing unit.

12. The management method for a manufacturing line according to claim 9,
wherein the obtaining the fluctuation characteristic includes:
obtaining an occurrence probability of an inventory quantity in the inventory by using an arrival fluctuation coefficient related to a distribution of arrival fluctuation of lots to the inventory sharing unit and a capability fluctuation coefficient related to a distribution of capability fluctuation of the inventory sharing unit, and
the obtaining the inventory information includes:
obtaining the upper limit inventory quantity of the inventory of the inventory sharing unit depending on an occurrence probability of the inventory quantity in the inventory.

13. The management method for a manufacturing line according to claim 9,
wherein the obtaining the fluctuation characteristic includes:
obtaining an occurrence probability of an inventory quantity in the inventory by using an arrival fluctuation coefficient related to a distribution of arrival fluctuation of lots to the inventory sharing unit and a capability fluctuation coefficient related to a distribution of capability fluctuation of the inventory sharing unit, and
the obtaining the inventory information includes:
obtaining the upper limit inventory quantity of the inventory of the inventory sharing unit and an average stay time of the inventory sharing unit depending on an occurrence probability of the inventory quantity in the inventory.

14. The management method for a manufacturing line according to claim 13,
wherein a constraint time is set in the inventory sharing unit, and
the obtaining the inventory information further includes:
determining whether or not the average stay time satisfies the constraint time.

15. The management method for a manufacturing line according to claim 1,
wherein the multiple process areas includes two or more process areas that are reenterable,
the obtaining the fluctuation characteristic includes:
obtaining an arrival fluctuation characteristic of a lot to each of the two or more process areas and a capability fluctuation characteristic of each of the two or more process areas, and
the obtaining the inventory information includes:
obtaining an upper limit inventory quantity of an inventory of each of the two or more process areas depending on the arrival fluctuation characteristic and the capability fluctuation characteristic.

16. The management method for a manufacturing line according to claim 15,
wherein the obtaining the fluctuation characteristic includes:
obtaining an arrival fluctuation coefficient related to a distribution of arrival fluctuation of a lot to each of the two or more process areas and a capability fluctuation coefficient related to a distribution of capability fluctuation of each of the two or more process areas; and
obtaining the upper limit inventory quantity of the inventory of each of the two or more process areas depending on the arrival fluctuation coefficient and the capability fluctuation coefficient.

17. The management method for a manufacturing line according to claim 15,
wherein the obtaining the inventory information further includes:
setting the upper limit inventory quantity that has been obtained as an appropriate capacity of the inventory of each of the two or more process areas.

18. The management method for a manufacturing line according to claim 15,
wherein the obtaining the inventory information further includes:
obtaining an average stay time of a lot in each of the two or more process areas depending on the arrival fluctuation characteristic and the capability fluctuation characteristic.

19. The management method for a manufacturing line according to claim 1,
wherein the multiple process areas includes:
a first process area; and
a second process area subsequent to the first process area, and
the obtaining the inventory information includes:
obtaining each of an average inventory quantity of the first process area and an average inventory quantity of the second process area depending on an arrival fluctuation characteristic of the first process area, a capability fluctuation characteristic of the first process area, an arrival fluctuation characteristic of the second process area, and a capability fluctuation characteristic of the second process area.

20. The management method for a manufacturing line according to claim 19,
wherein the obtaining the inventory information further includes:
obtaining a condition under which the average inventory quantity of the second process area is larger than the average inventory quantity of the first process area depending on the arrival fluctuation characteristic of the first process area, the capability fluctuation characteristic of the first process area, the arrival fluctuation characteristic of the second process area, and the capability fluctuation characteristic of the second process area.
